(19) United States
(12) Patent Application Publication
(10) Pub. No.: US 2012/0314655 A1
(43) Pub. Date: Dec. 13, 2012

(54) DATA TRANSMISSION AND RECEPTION WITH HARQ AND NETWORK CODING

(75) Inventors: FENG XUE, San Diego, CA (US); Stefan Brueck, Neunkirchen am Brand (DE); Siddhartha Mallik, San Diego, CA (US); Kiran K. Somasundaram, San Diego, CA (US); Christian Pietsch, Nuremberg (DE)

(73) Assignee: QUALCOMM Incorporated, San Diego, CA (US)

(21) Appl. No.: 13/493,828

(22) Filed: Jun. 11, 2012

Related U.S. Application Data
(60) Provisional application No. 61/496,496, filed on Jun. 13, 2011.

(51) Int. Cl. H04W 40/00

(52) U.S. Cl. 370/328

(57) ABSTRACT

Techniques for transmitting and receiving data with hybrid automatic retransmission (HARQ) and network coding via block operation are disclosed. In one design, a transmitter transmits a first block of packets to multiple receivers and receives ACK/NAK feedback for the first block of packets from the receivers. The transmitter identifies candidate packets for network coding based on the ACK/NAK feedback. A pool of candidate packets changes over time as more ACK/NAK feedback for transmitted packets is received from the receivers. The transmitter generates at least one network-coded packet based on the candidate packets. Each network-coded packet may be generated by channel coding each of at least two packets and combining the at least two packets after channel coding. The transmitter transmits another block of packets to the receivers. This block includes the at least one network-coded packet and may also include pending packets and/or new packets.

The present application claims priority to provisional U.S. Application Ser. No. 61/496,496, entitled “DATA TRANSMISSION AND RECEPTION WITH HARQ AND NETWORK CODING,” filed Jun. 13, 2011, and incorporated herein by reference in its entirety.

### BACKGROUND

I. Field

The present disclosure relates generally to communication, and more specifically to techniques for transmitting and receiving data in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A transmitter (e.g., a base station) may have packets to transmit to a number of receivers (e.g., UEs). The transmitter may transmit the packets for each receiver specifically to that receiver. A large amount of radio resources may be consumed by separately transmitting the packets for different receivers, as is typically done in many wireless networks.

### SUMMARY

Techniques for transmitting and receiving data with hybrid automatic retransmission (HARQ) and network coding via block operation are disclosed. A transmitter may transmit packets to multiple receivers. A receiver may successfully decode packets intended for other receivers but not its intended packets. The transmitter may generate and transmit network-coded packets, with each network-coded packet being generated based on at least two packets that have been correctly decoded by some receivers. The receivers may be able to recover their packets based on the network-coded packets as well as prior transmissions of their packets.

In one design, a transmitter may transmit a first block of packets to multiple receivers and may receive acknowledgement/negative acknowledgement (ACK/NAK) feedback for the first block of packets from the receivers. The transmitter may identify candidate packets for network coding based on the ACK/NAK feedback from all receivers. A pool of candidate packets may change over time as more ACK/NAK feedback for transmitted packets is received from the receivers. The transmitter may generate at least one network-coded packet based on the candidate packets.

Each of the network-coded packets may be generated by channel coding each of at least two packets and then combining the at least two packets after channel coding. The transmitter may transmit a subsequent block of packets to the receivers. This block may include the at least one network-coded packet and may also include pending packets and/or new packets. Block operation may ensure that (i) the receivers have sufficient time to decode the packets and send ACK/NAK feedback and (ii) the transmitter has sufficient time to identify candidate packets for network coding and generate and transmit another block of packets.

Various aspects and features of the disclosure are described in detail below.

### BRIEF DESCRIPTION OF THE DRAWINGS

FIG. 1 shows a wireless communication network.

FIG. 2 shows a base station communicating with multiple UEs.

FIG. 3 shows data transmission from a base station to a UE with HARQ.

FIG. 4 shows a process for transmitting data with HARQ and network coding.

FIGS. 5A and 5B show transmission of packets in blocks.

FIGS. 6A and 6B show examples of data transmission with HARQ and network coding when partial ACK/NAK feedback is available.

FIG. 7 shows an example of data transmission with HARQ and network coding when full ACK/NAK feedback is available.

FIG. 8 shows an example of data transmission from a base station to two UEs with HARQ and network coding.

FIGS. 9 and 10 show block diagrams of a transmitter and a receiver, respectively, supporting HARQ and network coding.

FIG. 11 shows a process for transmitting data with network coding.

FIG. 12 shows a process for receiving data sent with network coding.

FIG. 13 shows a process for decoding packets sent with network coding.

FIG. 14 shows a block diagram of a transmitter and a receiver.

FIG. 15 shows a block diagram of a base station and a UE.

### DETAILED DESCRIPTION

The techniques described herein may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 includes IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi and Wi-Fi Direct), IEEE 802.16 (WiMAX), IEEE 802.20, Flash-OFDM®, etc. UTRA, E-UTRA, and GSM are part of Universal Mobile Telecommunication System (UMTS). 3GPP Long Term Evolution (LTE) and LTE-Advanced (LTE-A), in both frequency division duplexing (FDD) and time division duplexing (TDD), are recent releases of UMTS that use E-UTRA, which employs OFDMA on the downlink and SC-FDMA on the uplink. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

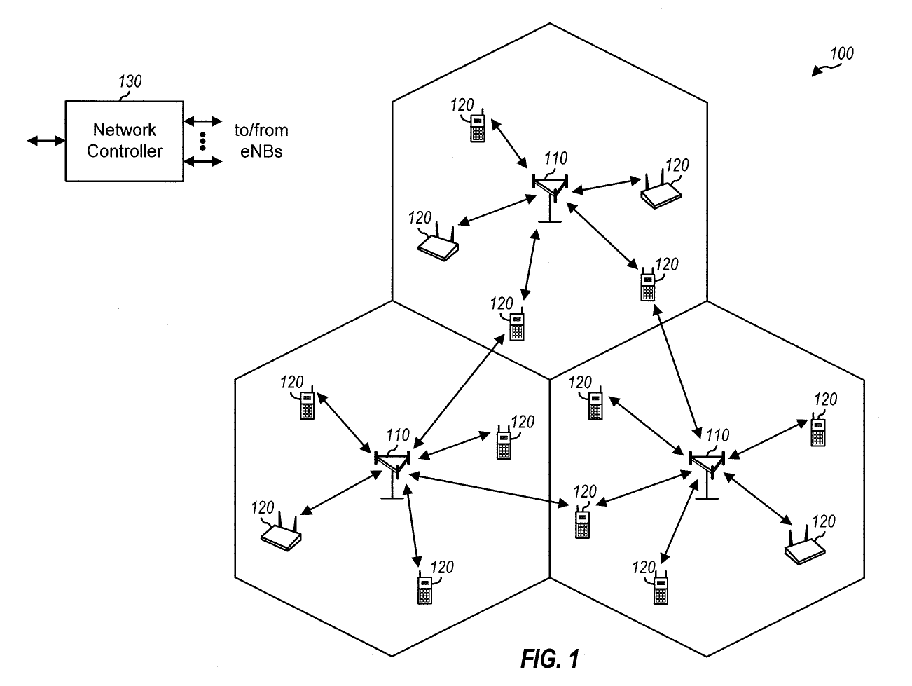

FIG. 1 shows a wireless communication network 100, which may be an LTE network or some other wireless network. Wireless network 100 may include a number of evolved Node Bs (eNBs) 110 and other network entities. An eNB may be an entity that communicates with the UEs and may also be referred to as a Node B, a base station, an access point, etc. Each eNB 110 may provide communication coverage for a particular geographic area and may support communication for the UEs located within the coverage area. To improve network capacity, the overall coverage area of an eNB may be partitioned into multiple (e.g., three) smaller areas. Each smaller area may be served by a respective eNB subsystem. In 3GPP, the term “cell” can refer to a coverage area of an eNB and/or an eNB subsystem serving this coverage area. In general, an eNB may support one or multiple (e.g., three) cells. The term “cell” may also refer to a carrier on which an eNB operates.

A network controller 130 may couple to a set of eNBs and may provide coordination and control for these eNBs. Network controller 130 may communicate with the eNBs via a backhaul. The eNBs may also communicate with one another via the backhaul.

UEs 120 may be dispersed throughout the wireless network, and each UE may be stationary or mobile. A UE may also be referred to as a mobile station, a terminal, an access terminal, a subscriber unit, a station, a node, etc. A UE may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc. A UE may communicate with eNBs, other UEs, etc.

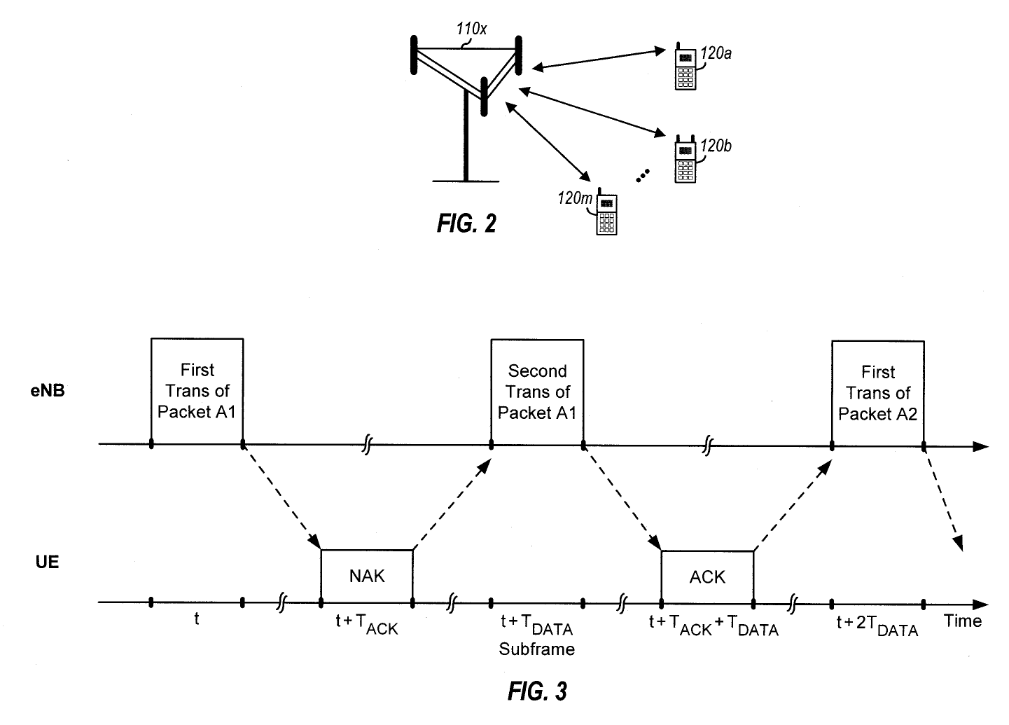

FIG. 2 shows an eNB 110x communicating with M UEs 120a to 120m, where M may be any value greater than one. The eNB may transmit one or more packets to each UE. A packet may also be referred to as a transport block, a codeword, a data block, etc. The eNB may retransmit each packet that is decoded in error, so that each UE can correctly receive all packets intended for that UE.

Wireless network 100 may support data transmission with HARQ in order to improve reliability. Using HARQ, a transmitter (e.g., an eNB) may send an initial transmission of a packet and may send one or more additional transmissions of the packet, if needed, until the packet is decoded correctly by a receiver (e.g., a UE), or the maximum number of transmissions of the packet has occurred, or some other termination condition is encountered. After each transmission of the packet, the receiver may decode all received transmissions of the packet to attempt to recover the packet. The receiver may send an acknowledgement (ACK) if the packet is decoded correctly or a negative acknowledgement (NAK) if the packet is decoded in error. The transmitter may send another transmission of the packet if a NAK is received and may terminate transmission of the packet if an ACK is received.

FIG. 3 shows data transmission from an eNB to a UE with HARQ. The transmission timeline for each of the downlink and uplink directions may be partitioned into units of subframes. Each subframe may have a predetermined duration, e.g., one millisecond (ms). The UE may periodically estimate the channel response and/or channel quality of a wireless channel from the eNB to the UE and may send channel state information (CSI) to the eNB (not shown in FIG. 3). The CSI may include channel quality indicator (CQI), rank indicator (RI), precoding matrix indicator (PMI), etc. The eNB may use the CSI and/or other information to schedule the UE for data transmission on the downlink and to select one or more modulation and coding schemes (MCS) for the UE. An MCS may be selected for a packet such that the packet can be decoded correctly by the UE with high probability after a target number of transmissions of the packet. This target number of transmissions may be referred to as a target termination. The eNB may process (e.g., encode and modulate) a packet A based on the MCS and may send a first transmission of packet A to the UE in subframe t.

The UE may receive the first transmission of packet A1 from the eNB and may decode the first transmission. The UE may decode packet A1 in error and may send a NAK in subframe t+T_{ACK} , where T_{ACK} is a HARQ feedback delay which may have a duration of 4 subframes, or some other value. The eNB may receive the NAK from the UE and may send a second transmission of packet A1 in subframe t+T_{DATA}, where T_{DATA} is a HARQ retransmission delay and may be equal to 8, or 10, or some other value. The UE may receive the second transmission of packet A from the eNB and may decode the first and second transmissions of packet A. The UE may decode packet A1 correctly and may send an ACK in subframe t+T_{ACK}+T_{DATA} The eNB may receive the ACK from the UE and terminate transmission of packet A1. The eNB may process and send another packet A2 in similar manner.

Wireless network 100 may support HARQ with incremental redundancy (IR) and/or chase combining (CC). For HARQ with IR, a transmitter may transmit a different redundancy version of a packet whenever a NAK is received for the packet. For HARQ with CC, the transmitter may transmit the same redundancy version of a packet whenever a NAK is received for the packet. The techniques described herein may be used for both HARQ with IR and HARQ with CC. For clarity, much of the description below covers HARQ with IR.

For simplicity, FIG. 3 shows transmission of one packet with HARQ. In general, any number of packets may be transmitted concurrently in a given subframe. Each packet may be processed based on an MCS selected for that packet, or an MCS selected for all packets being transmitted concurrently, or a fixed MCS.

LTE supports synchronous HARQ on the uplink and asynchronous HARQ on the downlink. For synchronous HARQ, all transmissions of a packet may be sent in evenly spaced subframes of one time interlace, e.g., as shown in FIG. 3. The UE may send ACK/NAK feedback after a predetermined delay of t_{TCK} subframes from a transmission of a packet, and the eNB may send another transmission of the packet after a predetermined delay of t_{DATA} subframes from the prior transmission of the packet. For example, with a 8-ms HARQ timeline, the UE may receive a transmission of a packet in subframe t, send ACK/NAK feedback in subframe t+4, and receive another transmission of the packet in subframe t+8. For asynchronous HARQ, a transmission of a packet may be scheduled and sent in any subframe. The techniques described herein may be used for both synchronous HARQ and asynchronous HARQ.

Referring back to FIG. 2, eNB 110x may transmit data to UEs 120a to 120m using HARQ. The eNB may transmit one or more packets to each UE. For HARQ, the eNB may encode a data packet to generate a coded packet and may partition the coded packet into multiple (e.g., four) redundancy versions. Each redundancy version may include different coded data (e.g., different parity bits) for the data packet. A redundancy version of a packet may also be referred to as a channel code of the packet. The eNB may transmit a first redundancy version of a packet to a UE. If the UE decodes the packet in error based on the first redundancy version, then the UE may send a NAK, and the eNB may transmit a second redundancy version of the packet to the UE. The UE may combine and decode all redundancy versions of the packet in order to improve the likelihood of correctly decoding the packet.

Conventionally, the eNB may transmit packets to specific UEs and may retransmit each packet that is decoded in error by a recipient UE. Retransmission of each packet individually may ensure that each packet can be correctly decoded by the recipient UE. However, retransmission of individual packets may be inefficient in certain scenarios, as described below.

In an aspect of the present disclosure, a transmitter (e.g., an eNB) may transmit data to multiple receivers (e.g., UEs) with HARQ and network coding via block operation. For network coding, the transmitter may combine multiple packets to form a network-coded packet and may transmit the network-coded packet (e.g., instead of separately transmitting the multiple packets used to generate the network-coded packet). For network coding before channel coding, the transmitter may combine data bits of multiple data packets and may then encode the combined data bits to generate a network-coded packet. For network coding after channel coding, the transmitter may encode each of multiple data packets to obtain a corresponding coded packet and may combine multiple coded packets to obtain a network-coded packet. Network coding after channel coding may provide certain advantages such as improved performance since network coding after channel coding may enable more efficient processing of soft information and may be able to achieve higher data rate or greater reliability as compared to network coding before channel coding. For network coding both before and after channel coding, a network-coded packet may be generated based on two or more packets using a suitable function, e.g., a linear function such as an exclusive OR (XOR) function

A network-coded packet may be used by one or more receivers to recover one or more packets decoded in error. For example, an eNB may transmit a packet A to UE-1 and a packet B to UE-2. Each UE may decode each packet sent by the eNB. UE-1 may decode its packet A in error but may decode the other packet B correctly. Conversely, UE-2 may decode its packet B in error but may decode the other packet A correctly. The eNB may generate a network-coded packet X based on packets A and B, e.g., by encoding packets A and B to generate two coded packets and then XORing the code bits of the two coded packets. The eNB may transmit the network-coded packet (instead of retransmitting packet A and also packet B). UE-1 may be able to decode its packet A based on the correctly decoded packet B, the initial transmission of packet A, and the transmission of the network-coded packet, as described below. Similarly, UE-2 may be able to decode its packet B based on the correctly decoded packet A, the initial transmission of packet B, and the transmission of the network-coded packet.

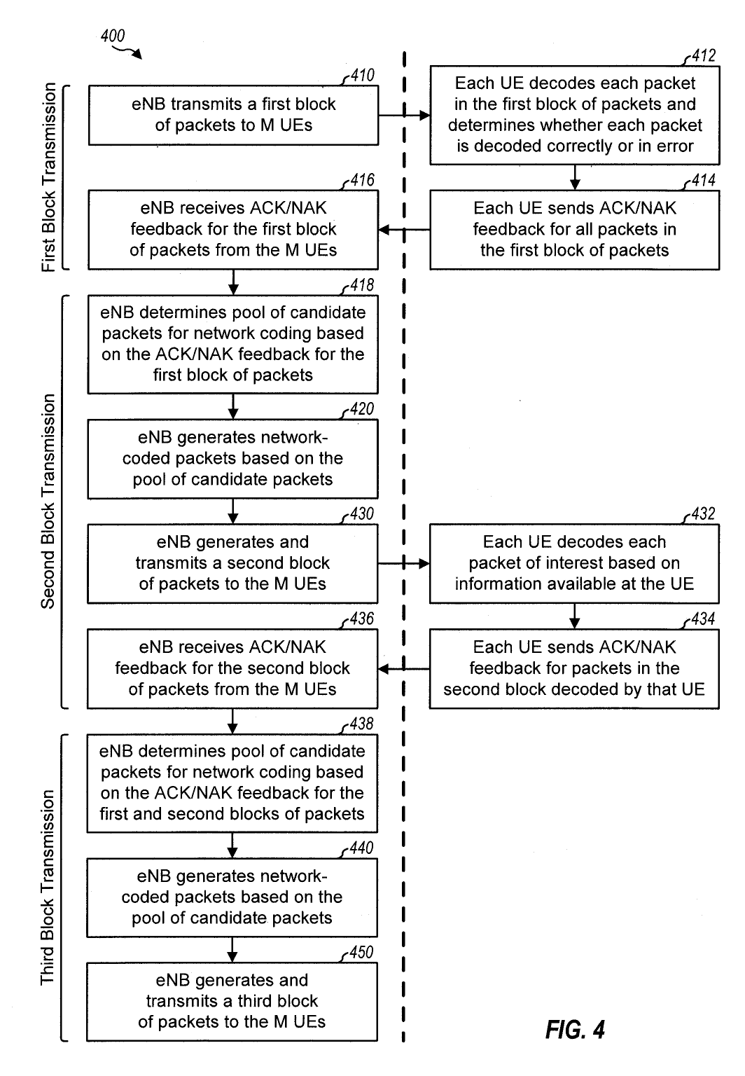

FIG. 4 shows an exemplary design of a process 400 for transmitting data by an eNB to a group of M UEs with HARQ and network coding via block operation, where M may be any value greater than one. The eNB may encode Nᵢ data packets for each UEᵢ to obtain Nᵢ coded packets, where Nᵢ may be one or greater. In general, the same number of packets may be transmitted to all UEs, or different numbers of packets may be transmitted to different UEs. For simplicity, the description below assumes the same number of packets (N) being transmitted to all UEs. The eNB may generate one or more redundancy versions of each packet. The eNB may transmit a first block of packets to the M UEs (block 410). The first block of packets may include the first redundancy version of each of N*M packets for the M UEs. In one design, the eNB may transmit the packets for each UE on resources assigned to that UE. In another design, the eNB may transmit the packets for the M UEs on resources shared by these UEs. In both designs, the resources may correspond to resource blocks, subcarriers, orthogonal sequences, etc. The eNB may transmit the first block of packets in one or more subframes. For example, the eNB may select packets for the M UEs in a round robin manner and may transmit one or more selected packets in each subframe.

Each UE may decode each packet in the first block of packets transmitted by the eNB and may determine whether a given packet is decoded correctly or in error (block 412). Each UE may send ACK/NAK feedback for all packets in the first block of packets (block 414). In one design, each UE may send ACK/NAK feedback based on a HARQ timeline. In this design, a UE may receive a packet in a particular subframe and may send ACK/NAK feedback for the packet T_{ACK} subframes later.

The eNB may receive ACK/NAK feedback for the first block of packets from the M UEs (block 416). The eNB may determine a pool of candidate packets for network coding based on the ACK/NAK feedback for the first block of packets (block 418). The candidate packets may include packets decoded in error by the recipient UEs, but decoded correctly by other UEs, as described in further detail below. The eNB may generate network-coded packets based on the pool of candidate packets (block 420). The eNB may generate a second block of packets, which may include zero or more network-coded packets, zero or more pending packets transmitted earlier in the first block of packets, and zero or more new packets (block 430). A pending packet is a packet for which a transmission of the packet has been sent but which has not been decoded correctly by a recipient receiver. A new packet is a packet for which no transmission of the packet has been sent.

The eNB may transmit the second block of packets to the M UEs (also block 430). For block 430, the eNB may transmit the second redundancy version of a pending packet, the first redundancy version of a network-coded packet, and/or the first redundancy version of a new packet.

Each UE may receive the second block of packets from the eNB. Each UE may decode each packet of interest to that UE based on information available at the UE from the transmission of the first and second blocks of packets, as described below (block 432). Each UE may determine whether each packet of interest is decoded correctly or in error and may send ACK/NAK feedback for packets in the second block which were decoded by that UE (block 434).

The eNB may receive ACK/NAK feedback for the second block of packets from the M UEs (block 436). The eNB may determine the pool of candidate packets for network coding based on the ACK/NAK feedback for the first and second blocks of packets from all UEs (block 438). More candidate packets may identified after transmission of the second block of packets, and the eNB may have more opportunities to generate network-coded packets based on the candidate packets. The eNB may generate network-coded packets based on the pool of candidate packets (block 440). The eNB may generate and transmit a third block of packets, which may include one or more network-coded packets, to the M UEs (block 450).

Transmissions of subsequent blocks of packets and transmission of ACK/NAK feedback may proceed in similar manner. Due to ACK/NAK feedback delay, the eNB may or may not have ACK/NAK feedback for all packets transmitted by the eNB when the eNB is ready to generate a new block of packets for the M UEs. The eNB may determine the pool of candidate packets for network coding based on the available ACK/NAK feedback at the eNB.

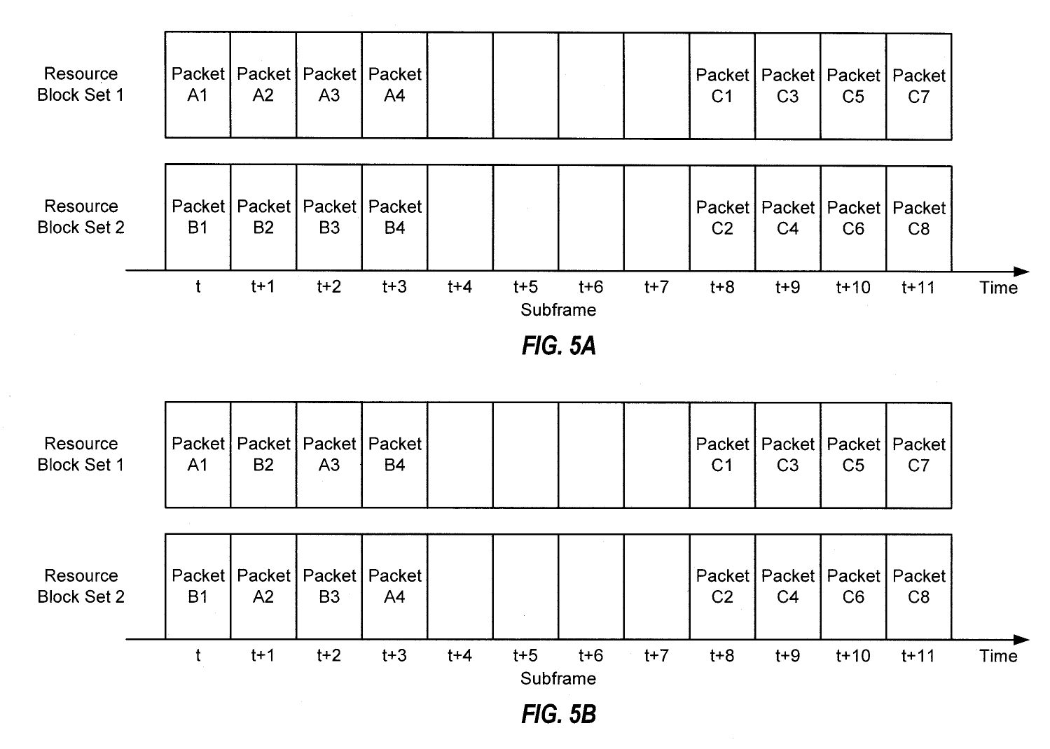

FIGS. 5A and 5B show examples of data transmission from an eNB to two UEs with HARQ and network coding when partial ACK/NAK feedback is available. Partial ACK/NAK feedback refers to availability of ACK/NAK feedback for only a subset of transmitted packets when determining which packets to transmit in a subsequent transmission. In the example shown in FIGS. 5A and 5B, a HARQ timeline with a HARQ feedback delay of 4 subframes and a HARQ retransmission delay of 8 subframes is utilized. The eNB may transmit a first block of packets to UE-1 and UE-2 in subframes t to t+3. The first block may include four packets A1 to A4 intended for UE-1 and four packets B1 to B4 intended for UE-2. In the example shown in FIGS. 5A and 5B, the eNB transmits packets A1 and B1 in subframe t, packets A2 and B2 in subframe t+1, packets A3 and B3 in subframe t+2, and packets A4 and B4 in subframe t+3.

In the example shown in FIG. 5A, the eNB transmits packets A1 to A4 on a first set of resource blocks assigned to UE-1 and transmits packets B1 to B4 on a second set of resource blocks assigned to UE-2. Each UE may be assigned resource blocks associated with higher CQI for that UE, which may improve decoding performance. Resource blocks may be dynamically or semi-statically assigned to each UE. In the example shown in FIG. 5B, the eNB transmits packets A1 to A4 and packets B1 to B4 on alternating resource blocks in the first and second sets of resource blocks. This design may provide frequency diversity for each UE. A combination of the designs in FIGS. 5A and 5B may also be used. For example, packets for each UE may be initially transmitted on different resource blocks to obtain diversity. Thereafter, packets for each UE may be transmitted on resource blocks with higher CQI for that UE.

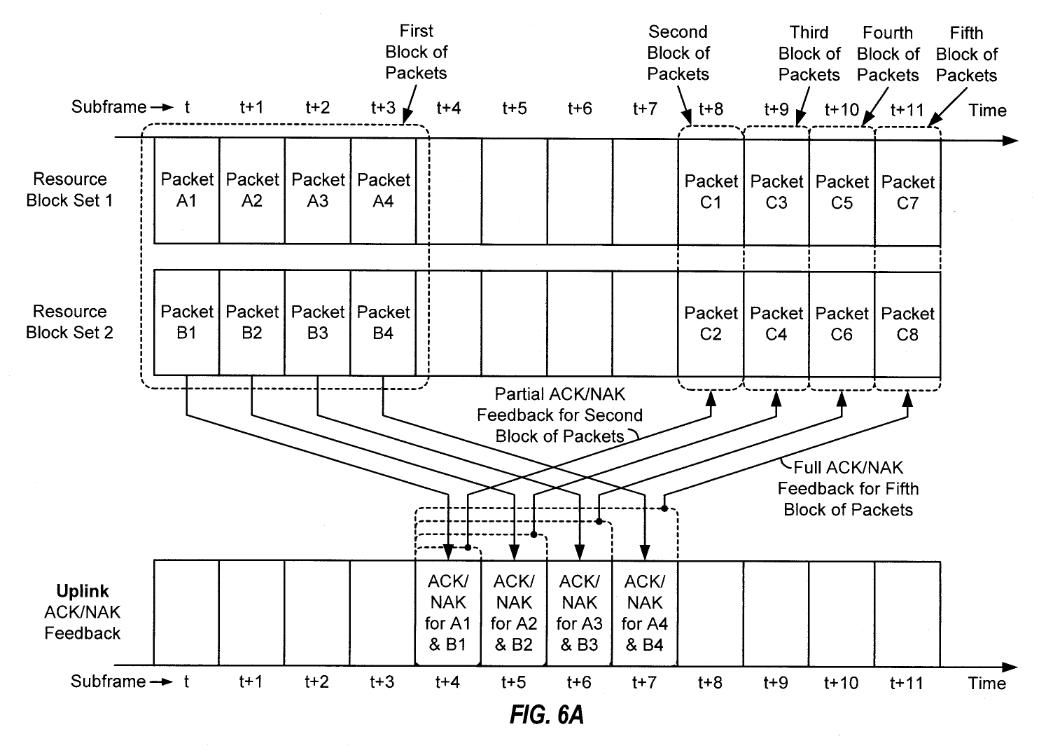

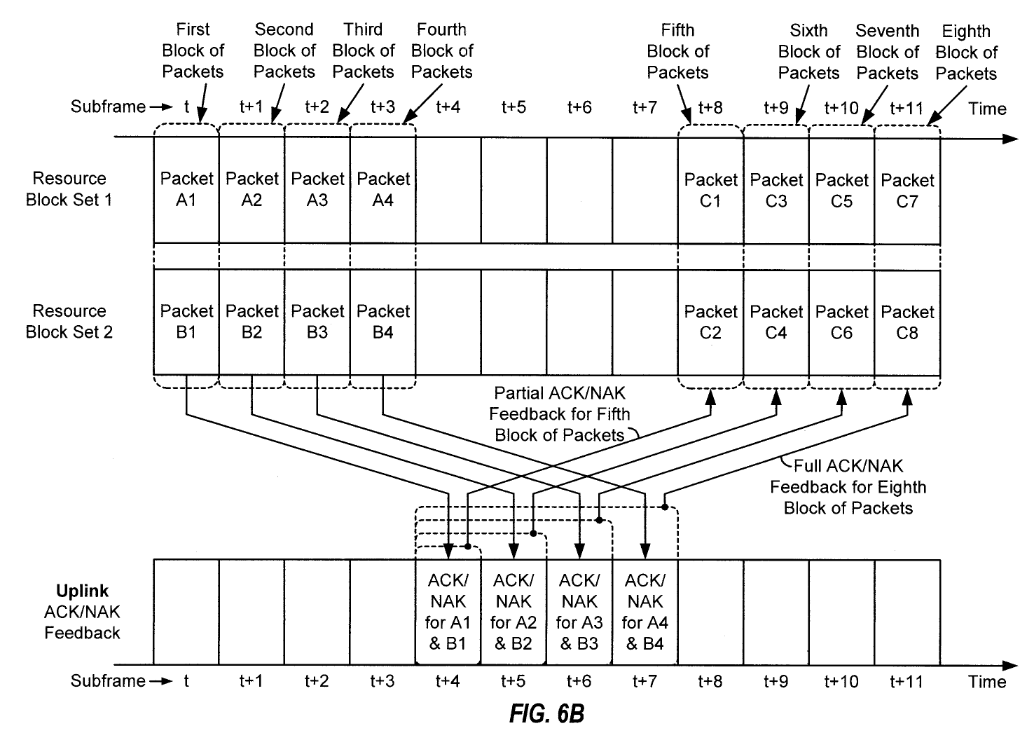

FIG. 6A shows an example of data transmission with HARQ and network coding with partial ACK/NAK feedback. The eNB may transmit the first block of packets A1 to A4 and packets B1 to B4 as described above for FIG. 5A. Each UE may receive and decode each packet in the first block of packets transmitted by the eNB. In one design, each UE may send ACK/NAK feedback for each packet based on the HARQ timeline. For example, each UE may send ACK/NAK feedback for packets A1 and B1 in subframe t+4, ACK/NAK feedback for packets A2 and B2 in subframe t+5, ACK/NAK feedback for packets A3 and B3 in subframe t+6, and ACK/NAK feedback for packets A4 and B4 in subframe t+7.

The eNB may transmit a second block of packets C1 and C2 in subframe t+8 in accordance with the HARQ retransmission delay of 8 subframes. The eNB may determine which packets to transmit in subframe t+8 based on partial ACK/NAK feedback for packets A1 and B1 received from UEs 1 and 2 in subframe t+4. In particular, the eNB may determine a pool of candidate packets for network coding in subframe t+8 based on the ACK/NAK feedback for A1 and B1 and may generate network-coded packets, if possible, based on the pool of candidate packets.

Table 1 shows a design of determining packets C1 and C2 based on ACK/NAK feedback for packets A1 and B1 from UEs 1 and 2. As shown in Table 1, the eNB may transmit a new packet if packet A1 is decoded correctly by UE-1 and may also transmit a new packet if packet B1 is decoded correctly by UE-2. The eNB may transmit a network-coded (NC) packet generated based on packets A1 and B1 if (i) UE-1 decoded its packet A1 in error but decoded packet B1 correctly and (ii) UE-2 decoded its packet, B1, in error but decoded packet A1 correctly. The eNB may retransmit packets A1 and B1 in other cases. Packet C1 in the second block may thus correspond to a second redundancy version of packet A1, a first redundancy version of a network-coded packet, or a first redundancy version of a new packet. Packet C2 in the second block may correspond to a second redundancy version of packet B1 or a first redundancy version of a new packet.

TABLE 1
Determining Packets to Transmit
Based on Partial ACK/NAK Feedback

| ACK/NAK Feedback | | ACK/NAK Feedback | | Packets to | |
|---|---|---|---|---|---|
| from UE 1 | | from UE 2 | | Transmit by eNB | |
| Packet A1 | Packet B1 | Packet B1 | Packet A1 | Packet C1 | Packet C2 |
| ACK | X | ACK | X | New packet | New packet |
| ACK | X | NAK | X | New packet | Packet B1 |
| NAK | X | ACK | X | Packet A1 | New packet |
| NAK | ACK | NAK | ACK | NC packet | New packet |
| NAK | ACK | NAK | NAK | Packet A1 | Packet B1 |
| NAK | NAK | NAK | ACK | Packet A1 | Packet B1 |
| NAK | NAK | NAK | NAK | Packet A1 | Packet B1 |

Table 1 shows an exemplary design of determining which packets to transmit in the second block of packets based on partial ACK/NAK feedback for transmitted packets A1 and A2. Packets C1 and C2 may also be determined in other manners, e.g., based on rules different from the rules in Table 1.

Referring back to FIG. 6A, the eNB may determine a third block of packets C3 and C4 to transmit in subframe t+9 based on partial ACK/NAK feedback for packets A1, A2, B1 and B2 received from UEs 1 and 2 in subframes t+4 and t+5. The eNB may determine a pool of candidate packets for network coding in subframe t+9 based on the ACK/NAK feedback for packets A1, A2, B1 and B2 and may generate network-coded packets, if possible, based on the pool of candidate packets. For example, the eNB may generate a network-coded packet based on packets A1 and B2 if packet A1 is decoded correctly by UE 2 and packet B2 is decoded correctly by UE 1. This network-coded packet may be used by UE 1 to decode its packet A1 and also by UE 2 to decode its packet B2.

The eNB may determine a fourth block of packets C5 and C6 to transmit in subframe t+10 based on partial ACK/NAK feedback for packets A1 to A3 and packets B1 to B3 received from UEs 1 and 2 in subframes t+4 to t+6. The eNB may determine a pool of candidate packets for network coding in subframe t+10 based on the ACK/NAK feedback for packets A1 to A3 and packets B1 to B3 and may generate network-coded packets, if possible, based on the pool of candidate packets. For example, the eNB may generate a network-coded packet based on packets A3 and B1 if packet A3 is decoded correctly by UE 2 and packet B1 is decoded correctly by UE 1. This network-coded packet may be used by UE 1 to decode its packet A3 and also by UE 2 to decode its packet B1.

The eNB may determine a fifth block of packets C7 and C8 to transmit in subframe t+11 based on full ACK/NAK feedback for packets A1 to A4 and packets B1 to B4 received from UEs 1 and 2 in subframes t+4 to t+7. The eNB may determine a pool of candidate packets for network coding in subframe t+11 based on the ACK/NAK feedback for packets A1 to A4 and packets B1 to B4 and may generate network-coded packets, if possible, based on the pool of candidate packets.

In general, the eNB may determine a pool of candidate packets for network coding based on all ACK/NAK feedback available at the eNB. The eNB may have more ACK/NAK feedback in progressively later subframes and may have more opportunities to generate network-coded packets. Each network-coded packet may be generated based on (i) a packet intended for UE-1 but decoded correctly only by UE-2 and (ii) a packet intended for UE-2 but decoded correctly only by UE-1. The two packets may be transmitted in the same subframe or in different subframes.

FIG. 6B shows another way of viewing the exemplary data transmission in FIG. 6A. In FIG. 6B, the eNB may transmit a first block of packets in subframe t, with the first block including packets A1 and B2. The eNB may have no ACK/NAK feedback in the next subframe t+1 and may generate a second block of packets to include new packets A2 and B2. The eNB may transmit the second block of packets in subframe t+1. The eNB may generate a third block of new packets A3 and B3 and may transmit this block of packets in subframe t+2. The eNB may generate a fourth block of new packets A4 and B4 and may transmit this block of packets in subframe t+3.

The eNB may receive ACK/NAK feedback for the first block of packets in subframe t+4, generate a fifth block of packets based on this ACK/NAK feedback, and transmit the fifth block of packets in subframe t+8. The eNB may receive ACK/NAK feedback for the second block of packets in subframe t+5, generate a sixth block of packets based on the ACK/NAK feedback for the first and second blocks of packets, and transmit the sixth block of packets in subframe t+9. The eNB may receive ACK/NAK feedback for the third block of packets in subframe t+6, generate a seventh block of packets based on the ACK/NAK feedback for the first to third blocks of packets, and transmit the seventh block of packets in subframe t+10. The eNB may receive ACK/NAK feedback for the fourth block of packets in subframe t+7, generate an eighth block of packets based on the ACK/NAK feedback for the first to fourth blocks of packets, and transmit the eighth block of packets in subframe t+11. In general, the eNB may determine a pool of candidate packets in each subframe based on ACK/NAK feedback available at the eNB and may generate a block of packets based on the pool of candidate packets.

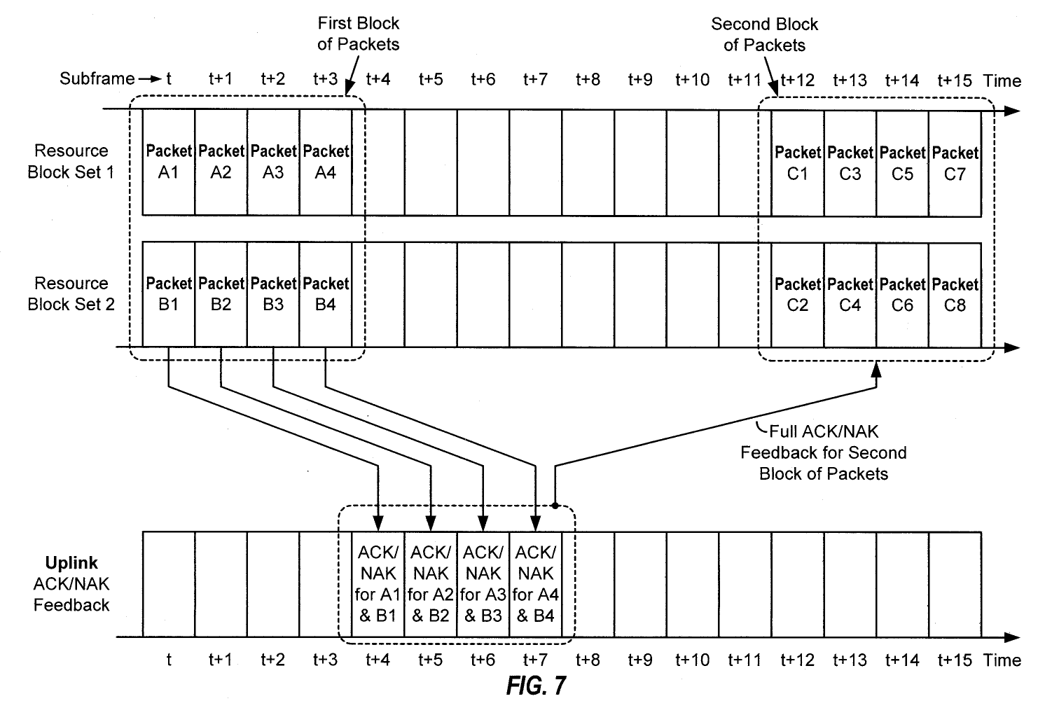

FIG. 7 shows an example of data transmission from an eNB to two UEs with HARQ and network coding when full ACK/NAK feedback is available. Full ACK/NAK feedback refers to availability of ACK/NAK feedback for all transmitted packets when determining which packets to send in a subsequent transmission. In the example shown in FIG. 7, a HARQ timeline with a HARQ feedback delay of 4 subframes and a HARQ retransmission delay of 12 subframes is utilized.

As shown in FIG. 7, the eNB may transmit a first block of packets to UE-1 and UE-2 in subframes t to t+3. The first block may include four packets A1 to A4 intended for UE-1 and four packets B1 to B4 intended for UE-2. The eNB may transmit packets A1 and B1 in subframe t, packets A2 and B2 in subframe t+1, packets A3 and B3 in subframe t+2, and packets A4 and B4 in subframe t+4.

Each UE may receive and decode each packet in the first block of packets transmitted by the eNB. Each UE may send ACK/NAK feedback for the first block of packets to the eNB. For example, each UE may send ACK/NAK feedback for packets A1 and B1 in subframe t+4, ACK/NAK feedback for packets A2 and B2 in subframe t+5, ACK/NAK feedback for packets A3 and B3 in subframe t+6, and ACK/NAK feedback for packets A4 and B4 in subframe t+7, as shown in FIG. 7. Each UE may also send ACK/NAK feedback for the first block of packets in other manners. For example, each UE may send ACK/NAK feedback for all packets in a single transmission in subframe t+7.

The eNB may receive full ACK/NAK feedback for packets A1 to A4 and packets B1 to B4 from UEs 1 and 2. The eNB may determine a second block of packets C1 to C8 to transmit starting in subframe t+12 based on the ACK/NAK feedback for packets A1 to A4 and packets B1 to B4 from UEs 1 and 2. Because full. ACK/NAK feedback for the entire first block of packets is available at the eNB, there may be more opportunities to generate network-coded packets. The eNB may generate as many network-coded packets as possible based on the ACK/NAK feedback. In one design, the eNB may determine (i) a first list of packets intended for UE-1 but decoded correctly only by UE 2 and (ii) a second list of packets intended for UE-2 but decoded correctly only by UE 1.

The eNB may generate a network-coded packet based on one packet in the first list and one packet in the second list. The number of network-coded packets may be dependent on the number of packets in the first list or the number of packets in the second list, whichever is smaller. The eNB may also retransmit each packet that is not decoded correctly by either UE. The eNB may also transmit one or more new packets if resources are available. The eNB may transmit the second block of packets C1 to C8 in subframes t+12 to t+15. Each packet in the second block may be a pending packet in the first block, a network-coded packet, or a new packet.

FIGS. 6A and 7 show examples in which the first block includes eight packets transmitted in four subframes t to t₊3. The first block may also include more or fewer packets transmitted in more or fewer subframes. For example, the first block may include 16 packets A1 to A8 and B1 to B8 transmitted in eight subframes t to t+7. Each subsequent block may include any number of packets and may be transmitted in any number of subframes. Each subsequently block may include zero or more network-coded packets, which may be determined based on ACK/NAK feedback from all UEs available at the eNB.

The eNB may determine a pool of candidate packets for network coding in various manners. In one design, the eNB may perform an exhaustive search to identify candidate packets. The eNB may initially evaluate an entire group of M UEs and may determine, for a set of M packets intended for the M UEs, whether each UE has decoded its packet in error but successfully decoded the M-1 packets intended for the M-1 other UEs. If the answer is YES, then the eNB may generate a network-coded packet based on all M packets in the set. If no such set of M packets exists, then the eNB may evaluate a group of M-1 UEs corresponding to a subset of the M UEs. The eNB may determine, for a set of M-1 packets intended for the M-1 UEs in the subset, whether each UE has decoded its packet in error but successfully decoded the M-2 packets intended for the M-2 other UEs. If the answer is YES, then the eNB may generate a network-coded packet based on all M-1 packets in the set. If no such set of M-1 packets exists, then the eNB may evaluate another group of M-1 UEs corresponding to a different subset of the M UEs. The eNB may evaluate different groups of M-1 UEs corresponding to all possible subsets of M UEs to identify sets of M-1 packets that can be used to generate network-coded packets. The eNB may then repeat the process and evaluate different groups of M-2 UEs corresponding to all possible subsets of M UEs to identify sets of M-2 packets that can be used to generate network-coded packets. The eNB may next evaluate different groups of progressively fewer UEs, down to different groups of two UEs, to identify sets of packets that can be used to generate network-coded packets.

A network-coded packet may be generated by combining multiple packets after channel coding. In one design of network coding after channel coding, each packet used to generate a network-coded packet may first be encoded to generate a coded packet. If the multiple packets have different lengths, then zero padding may be performed to obtain packets of the same length. Multiple coded packets for the multiple data packets used to generate the network-coded packet may then be combined, e.g., by performing bit-wise XOR of the code bits of the multiple coded packets. For example, bit-wise XOR of the code bits of two coded packets may be expressed as:

xᵢ=aᵢ⊕bᵢ, Eq (1)

where aᵢ is the i-th code bit of a first coded packet,

bᵢ is the i-th code bit of a second coded packet, and

xᵢ is the i-th code bit of the network-coded packet.

In the design shown in equation (1), the j-th redundancy version of packet A may be combined with the j-th redundancy version of packet B to generate the j-th redundancy version of the network-coded packet. A redundancy version of the network-coded packet may be transmitted.

In another design of network coding after channel coding, a network-coded packet may be generated by combining (e.g., XORing) selected redundancy versions of multiple packets. For each packet used to generate the network-coded packet, a redundancy version of that packet which has not been transmitted may be selected and used to generate the network-coded packet. For example, a redundancy version of a network-coded packet for packet C1 in Table 1 may be generated by combining a second redundancy version of packet A1 with a second redundancy version of packet B1. Another redundancy version of the network-coded packet may be generated based on a third redundancy version of packet A1 and a third redundancy version of packet B1. Another network-coded packet may be generated based on packet A1 and one or more other packets by combining the fourth redundancy version of packet A1 with one or more redundancy versions of one or more other packets. In general, a different redundancy version of a packet may be used whenever the packet is transmitted by itself or is used to generate a network-coded packet. This may allow each UE to receive different redundancy versions of the packet, which may improve the likelihood of correctly decoding the packet.

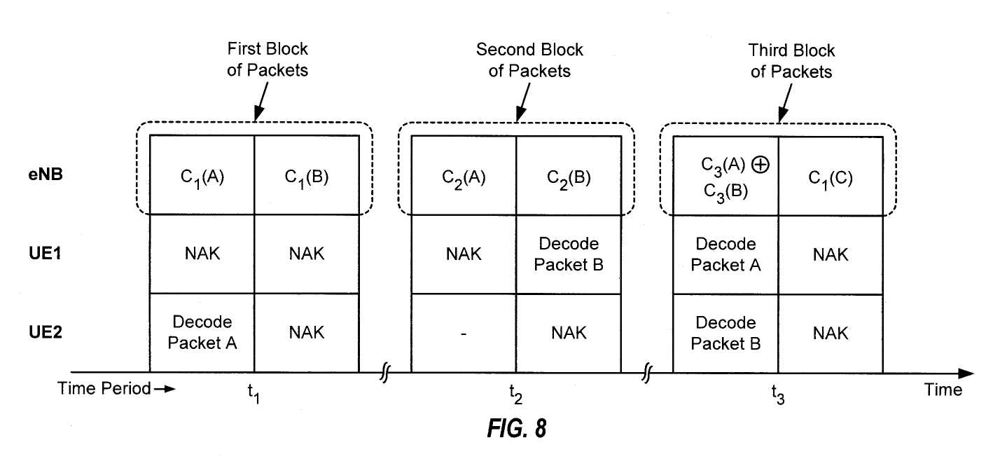

FIG. 8 shows an example of data transmission from an eNB to two UEs with HARQ and network coding. The eNB may transmit a first block of packets to the two UEs in time period t₁. The first block of packets may include a first redundancy version of packet A intended for UE 1, which may be denoted as C₁(A), and a first redundancy version of packet B intended for UE 2, which may be denoted as C₁(B).

UEs 1 and 2 may receive and decode the first block of packets from the eNB. UE-1 may decode packets A and B in error. UE-2 may decode its packet B in error but may decode packet A correctly. UEs 1 and 2 may send ACK/NAK feedback for packets A and B to the eNB, as shown in FIG. 8.

The eNB may receive the ACK/NAK feedback from UEs 1 and 2 and may generate a second block of packets based on the ACK/NAK feedback. The eNB may determine that there is no opportunity to generate a network-coded packet for the second block of packets. The second block may include a second redundancy version of packet A, which may be denoted as C₂(A), and a second redundancy version of packet B, which may be denoted as C₂(B). The eNB may transmit the second block of packets to UEs 1 and 2 in time period t₂.

UEs 1 and 2 may receive the second block of packets from the eNB. UE 1 may decode packet A in error but may decode packet B correctly. UE 2 may decode packet B in error and may skip decoding packet A since packet A has already been decoded correctly by UE 2. UEs 1 and 2 may send ACK/NAK feedback for packets A and B to the eNB, as shown in FIG. 8.

The eNB may receive the ACK/NAK feedback from UEs 1 and 2 and may generate a third block of packets based on all ACK/NAK feedback received from UEs 1 and 2. The eNB may determine that there is an opportunity to generate a network-coded packet based on packets A and B. The eNB may also determine that there is an opportunity to transmit a new packet since both packets A and B (which have not been decoded correctly by intended UEs 1 and 2, respectively) can be transmitted in one network-coded packet. The third block of packets may thus include a first redundancy version of a network-coded packet and a first redundancy version of a new packet C, which may be denoted as C₁(C). The first redundancy version of the network-coded packet may be generated based on a third redundancy version of packet A and a third redundancy version of packet B and may be denoted as C₃(A)⊕C₃ (B). The eNB may transmit the third block of packets to UEs 1 and 2 in time period t₃.

UEs 1 and 2 may receive the third block of packets from the eNB. UE-1 may decode packet A correctly based on the first and second redundancy versions of packet A received in time periods t₁ and t₂, the first redundancy version of the network-coded packet received in time period t₃, and the correctly decoded packet B, as described below. Similarly, UE-2 may decode packet B correctly based on the first and second redundancy versions of packet B received in time periods t₁ and t₂, the first redundancy version of the network-coded packet received in time period t₃, and the correctly decoded packet A.

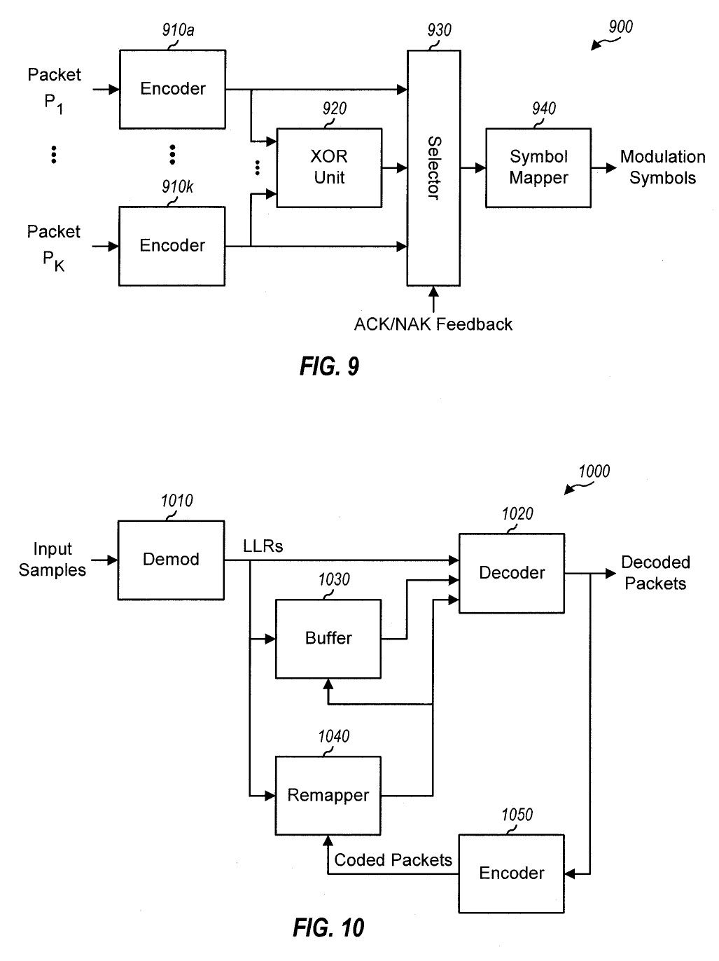

FIG. 9 shows a block diagram of a design of a transmitter 900 supporting HARQ and network coding. Transmitter 900 may be part of an eNB or some other entity and may be used for data transmission to multiple receiver (e.g., UEs). Within transmitter 900, K encoders 910a through 910k may receive K packets P₁ through P_{K}, respectively, which may be intended for one or more receivers. Each encoder 910 may encode its packet based on a selected coding scheme (e.g., a Turbo code, a convolutional code, a block code, etc.) and a selected code rate and may provide one or more redundancy versions of the packet. For example, if K=2, then encoder 910a may generate one or more redundancy versions of packet P₁, which may be denoted as C₁(P), C₂(P), C₃(P), etc. Encoder 910k may generate one or more redundancy versions of packet P₂, which may be denoted as C₁(P₂), C₂(P₂), C₃(P₂), etc.

An XOR unit 920 may receive different redundancy versions of packets P₁ through P_{K} and may generate network-coded packets. For example, XOR unit 920 may generate a network-coded packet based on the third redundancy versions of packets P₁ and P₂ for transmission in time interval t₃ in FIG. 8 by performing a bit-wise XOR of each code bit in the third redundancy version of packet P₁ with a corresponding code bit in the third redundancy version of packet P₂. The code bits of the network-coded packet may be given as follows:

z₁ =a₁⊕bₗ , z₂=a₂⊕b₂, z₃=a₃⊕b₃, Eq (2)

where a₁, a₂, a₃, etc., denote code bits of the third redundancy version of packet P₁,

b₁, b₂, b₃, etc., denote code bits of the third redundancy version of packet P₂, and

x₁, x₂, x₃, etc., denote code bits of the first redundancy version of the network-coded packet.

A selector 930 may receive redundancy versions of packets P₁ to P_{K} from encoders 910a to 910k, respectively, and redundancy versions of network-coded packets from XOR unit 920. Selector 930 may provide a suitable redundancy version of an appropriate packet based on ACK/NAK feedback from the UEs for prior transmissions of packets P₁ to P_{K}. Selector 930 may implement the rules in Table 1 when ACK/NAK feedback is available for two transmitted packets. Selector 930 may implement other rules for identifying candidate packets that can be combined to generate network-coded packets based on ACK/NAK feedback for more than two transmitted packets. A symbol mapper 940 may map each redundancy version of each packet from selector 930 to modulation symbols, which may be further processed and transmitted.

FIG. 10 shows a block diagram of a design of a receiver 1000 supporting HARQ and network coding. Receiver 1000 may be part of a UE or some other entity. Within receiver 1000, a demodulator (Demod) 1010 may receive input samples corresponding to a block of packets from a transmitter (e.g., an eNB) and may process (e.g., demodulate and detect) the input samples to obtain detected symbols, which may be estimates of modulation symbols transmitted for the block of packets. Demodulator 1010 may compute log-likelihood ratios (LLRs) of code bits of each packet based on the detected symbols. The LLR of each code bit may indicate the likelihood of the code bit being zero (‘0’) or one (‘1’) and may be computed in a manner known in the art. The LLRs may also be referred to as soft decisions, soft-decision information, soft information, etc.

A decoder 1020 may perform decoding for each packet and provide a decoded packet. If a first redundancy version of a given packet B is received, then decoder 1020 may decode the LLRs of the code bits of packet B and provide a decoded packet. If packet B is decoded in error, then the LLRs for the first redundancy version of packet B may be stored in a buffer 1030. If a subsequent redundancy version of packet B is received, then decoder 1020 may receive the LLRs for the current redundancy version of packet B from demodulator 1010 as well as LLRs for previously received and stored redundancy versions of packet B from buffer 1030. Decoder 1020 may decode the LLRs for all received redundancy versions of packet B and provide a decoded packet. If packet B is decoded in error, then the LLRs for the current redundancy version of packet B may be stored in buffer 1030.

A network-coded packet X may be received and may be generated based on packet B and one or more other packets that have been correctly decoded by receiver 1000. An encoder 1050 may encode each correctly decoded packet used to generate network-coded packet X to obtain a corresponding coded packet. A remapper 1040 may receive the LLRs for network-coded packet X as well as the code bits for all correctly decoded packets used to generate network-coded packet X. Remapper 1040 may process the LLRs for network-coded packet X to remove the contributions from correctly decoded packets used to generate network-coded packet X and may provide LLRs for packet B. Decoder 1020 may receive the LLRs for packet B from remapper 1040 as well as LLRs for all previously received and stored redundancy versions of packet B from buffer 1030. Decoder 1020 may decode the LLRs for all redundancy versions of packet B and provide a decoded packet. If packet B is decoded in error, then the LLRs for packet B obtained from network-coded packet X may be stored in buffer 1030.

In general, demodulator 1010 may provide LLRs for the current transmission of each packet received by receiver 1000. Buffer 1030 may store LLRs for each packet decoded in error and may provide the stored LLRs for a subsequent decoding of the packet. Encoder 1050 may encode each correctly decoded packet, used to generate a network-coded packet, in the same manner as channel coding performed by the transmitter for the packet. Remapper 1040 may receive LLRs for network-coded packets as well as code bits for correctly decoded packets used to generate the network-coded packets and may provide LLRs for packets used to generate the network-coded packets but decoded in error by receiver 1000. Decoder 1020 may perform decoding for each packet based on LLRs for all transmissions of the packet as well as LLRs for network-coded packets generated based on the packet.

Decoding by a receiver may be more clearly illustrated by the example shown in FIG. 8. In time period t₃ in FIG. 8, UE 1 may have correctly decoded packet B intended for UE 2 and may also receive a network-coded packet generated based on packets A and B, or C₃(A)⊕C₃(B). The code bits of the network-coded packet may be given as shown in equation (1). UE 1 knows the code bits {bᵢ} for correctly decoded packet B but does not know the code bits {aᵢ} for its packet A. UE 1 may estimate code bits {xᵢ} and LLRs of the network-coded packet. The code bits of the network-coded packet may be remapped based on the code bits of packet P₂, as follows:

âᵢ=xᵢ⊕bᵢ, Eq (3)

where âᵢ is an estimated code bit of packet A. The estimated code bits of packet A may be decoded by themselves to recover packet A and/or may be combined with other soft information for these code bits for final decoding.

The LLRs of the code bits xᵢ of the network-coded packet may be computed based on detected symbols for the network-coded packet and may be given as p(xᵢ|y), where y denotes detected symbols for the network-coded packet obtained from a received signal at a receiver. The detected symbols are corrupted by channel noise and other factors. To decode packet A, the LLRs of the code bits aᵢ of packet A are needed and may be given as p(aᵢ|y). The LLRs of the code bits of packet A may be obtained from (i) the LLRs of the code bits of the network-coded packet and (ii) the code bits of packet B. The LLRs of the code bits of packet A may be determined as follows:

If bᵢ=0, then Eq (4)
p(aᵢ=0|y)=p(xᵢ=0|y), and
p(aᵢ=1|y)=p(xᵢ=1|y),

If bᵢ=1, then
p(aᵢ=0|y)=p(xᵢ=1|y), and
p(aᵢ=1|y)=p(xᵢ=0|y)
   where p(aᵢ=0|y) is the probability of code bit xᵢ being 0 given detected symbols y.

In equation set (4), if bᵢ=0, then the LLR of code bit aᵢ of packet A may be set equal to the LLR of code bit xᵢ of the network-coded packet, or p(aᵢ|y)=p(xᵢ|y). Conversely, if bᵢ=1, then the LLR of code bit aᵢ of packet A may be set to the “swap” of the LLR of code bit xᵢ of the network-coded packet. Equation set (4) may be applied on a bit-by-bit basis for each code bit of the network-coded packet received in time period t₃.

UE-1 may decode packet A based on the LLRs for the first redundancy version of packet A obtained in time period t₁, the LLRs for the second redundancy version of packet A obtained in time period t₂, and the LLRs for the third redundancy version of packet A obtained from the network-coded packet received in time period t₃.

For clarity, much of the description above is for data transmission to two receivers/UEs. In general, a transmitter (e.g., an eNB) may transmit data to M receivers (e.g., UEs), where M may be any value greater than one. In one design, the transmitter may generate a network-coded packet X for K receivers based on K packets P₁ to P_{K} transmitted previously, where K≦M, as follows:

C(X)=C(P₁)⊕C(P₂)⊕ . . . ⊕C(P_{K}), Eq (5)

where C(Pᵢ) is a redundancy version of packet Pᵢ.

Equation (5) shows network coding after channel coding, and the network-coded packet is generated based on a redundancy version of each of the K packets P₁ to P_{K}. The same redundancy version or different redundancy versions of the K packets may be used to generate the network-coded packet. Decoding performance may be improved by using a redundancy version that has not been transmitted for each of the K packets, as described above.

Packet Pᵢ may be intended for UE i and may be decoded in error by UE i but decoded correctly by each remaining UE. If K is equal to M, then the network-coded packet may be generated based on M packets intended for the M UEs, with each packet being decoded by all UEs except for the intended UE. This network-coded packet may be used by all M UEs, and each UE may use the network-coded packet to decode its intended packet. If K is less than M, then the network-coded packet may be generated based on K packets intended for K UEs, which are a subset of the M UEs. This network-coded packet may be used by the K UEs, and each UE may use the network-coded packet to decode its intended packet. K may be the same for all network-coded packets. Alternatively, K may be different for different network-coded packets.

A UE may receive a network-coded packet generated based on K packets P₁ to P_{K}, which may include a packet P₁ intended for the UE. The UE may obtain LLRs and code bits {xᵢ} of the network-coded packet based on detected symbols for the network-coded packet. The UE may decode its intended packet P₁ in error but may have correctly decoded the remaining K-1 packets P₂ to P_{K}. The UE may obtain code bits {bᵢ} to {kᵢ} of packets P₂ to P_{K}, respectively, by encoding the correctly decoded packets P₂ to P_{K}. The redundancy versions of the K packets may be denoted as C(P₁)={aᵢ}, C(P₂)={bᵢ}, . . . , and C(P_{K})={kᵢ}.

In one design, the UE may XOR the code bits of the K-1 packets decoded correctly by the UE, as follows:

qᵢ=bᵢ⊕cᵢ⊕ . . . ⊕kᵢ, Eq (6)

where bᵢ to kᵢ are code bits of packets P₂ to P_{K}, respectively, and qᵢ is a combined code bit for the K-1 correctly decoded packets.

The UE may determine the LLRs of the code bits of packet P₁ based on the LLRs of the code bits of the network-coded packet and the combined bits, e.g., as shown in equation set (4). The UE may decode the LLRs of the code bits of packet P₁ obtained from prior transmissions of packet P₁ as well as the LLRs of the code bits of packet P₁ obtained from the network-coded packet.

In another design, the code bits of the network-coded packet may be remapped as follows:

â₌ₓᵢ⊕bᵢ⊕cᵢ⊕ . . . ⊕kᵢ. Eq (7)

If bᵢ⊕cᵢ⊕ . . . ⊕kᵢ=0, then the LLRs of the estimated code bits âᵢ of packet P₁ intended for the UE may be set equal to the LLRs of code bits xᵢ. Otherwise, the LLRs of the estimated code bits âᵢ may be set equal to the swapped of the LLRs of code bits xᵢ, as shown in equation (4).

An eNB may select a group of M UEs for data transmission with HARQ and network coding. These UEs may be selected based on various criteria such as CQI, data requirements, etc. Better performance may be obtained by selecting UEs with similar CQI, so that all UEs have similar likelihood of correctly decoding each packet. These M UEs may be part of a multicast group, and multicast mechanism may be used to establish the group and to terminate the group. These UEs may be directed to decode packets sent to all UEs in the group and to provide ACK/NAK feedback for the packets.

For a unicast data transmission to a specific UE in LTE, an eNB may send control information on a Physical Downlink Control Channel (PDCCH) and may send one or more packets on a Physical Downlink Shared Channel (PDSCH) to the UE. The control information may convey pertinent parameters for receiving and decoding the packet(s) sent on the PUSCH. The control information may be scrambled with a Radio Network Temporary Identifier (RNTI) assigned to the UE. For multicast data transmission to a group of UEs with network coding, if the control information for each UE is scrambled with the RNTI of that UE, then other UEs in the group may be unable to receive the control information. Each UE would then be unable to receive and decode packets sent to other UEs.

Various mechanisms may be used to enable all UEs in a group of UEs to receive and decode packets for other UEs. In a first design, a special RNTI may be assigned to the group of UEs and may be referred to as a NC-RNTI. The NC-RNTI may be used to scramble control information sent on the PDCCH to the group of UEs. The control information may include pertinent parameters used to receive and decode a block of packets transmitted to the group of UEs. Each UE in the group may receive control information sent on the PDCCH to the group of UEs based on the NC-RNTI. Each UE may receive and decode the block of packets based on the control information recovered by that UE with the NC-RNTI. In a second design, the eNB may send signaling to convey a scrambling sequence for each packet to the group of UEs. The signaling may be sent on the PDCCH and/or the PDSCH. In a third design, the eNB may send signaling to convey a set of scrambling sequences to the group of UEs. Each UE may perform blind decoding based on the scrambling sequences in the set. Various mechanisms used to support multicast data transmission to a group of UEs may be used to support data transmission with network coding to a group of UEs.

The eNB may send signaling to convey whether a packet is a network-coded packet and which packets are used to generate the network-coded packet. In one design, control information for a packet and/or the packet itself may include a flag to indicate whether the packet is a network-coded packet. In one design, control information for a network-coded packet and/or the network-coded packet itself may include information indicating which packets are used to generate the network-coded packet. If up to Nᵢ packets may be transmitted to each UE i in a group of M UEs and if a network-coded packet can be generated based up to K packets for up to K UEs, then the number of bits to indicate which packets are used to generate the network-coded packet may be given as N_{bits}=K* {log₂(M)+log₂(N)}.

Each UE may decode all packets transmitted to the group of UEs. If the group includes M UEs and if up to Nᵢ packets may be transmitted to each UE i in the group, then the number of packets to decode by each UE may be given as

$${N}_{packets} = {\sum }_{i = 1}^{M} {N}_{i} .$$

Each UE may forward correctly decoded packets for that UE to upper layers. Each UE may store packets intended for that UE but decoded in error as well as packets intended for other UEs but correctly decoded packets by the UE.

Each UE may decode all packets of interest and may send ACK/NAK feedback for the decoded packets. The ACK/NAK feedback may be sent in various manners. In one design, a UE may send an ACK or a NAK for each packet. In another design, the UE may send only ACKs for packets decoded correctly, and NAKs may be assumed by the absence of ACKs. In yet another design, the UE may aggregate or bundle ACKs and/or NAKs for multiple packets and may send the aggregated or bundled ACK/NAK. The UE may also send ACK/NAK feedback in other manners. The UE may send ACK/NAK feedback on a Physical Uplink Control Channel (PUCCH) and/or a Physical Uplink Shared Channel (PUSCH).

In one design, each packet may be assigned a sequence number. This may enable ACK/NAK to be uniquely addressed to a packet. The sequence number may be sent explicitly on the PDCCH and/or PDSCH, or embedded in a packet, or conveyed in other manners. The sequence number may also be implicitly assigned to a packet, e.g., based on the order in which packets are sent. In another design, ACK/NAK for packets may be addressed based on other information associated with the packets.

Sending a block of packets at a time (e.g., as shown in FIGS. 5A to 8) may improve data performance for HARQ with network coding. In particular, transmitting packets in blocks may provide more opportunities to generate network-coded packets and may also reduce delay for data transmission with HARQ and network coding. In contrast, performance may be poor and delay may be extensive for a sequential scheme in which one packet is transmitted at a time to a group of UEs with HARQ and network coding. For example, an eNB may transmit a first packet to two UEs, then wait for ACK/NAK feedback from the UEs, then transmit the first packet or a second packet to the UEs based on the ACK/NAK feedback for the first packet, then wait for ACK/NAK feedback from the UEs, then transmit the first or second packet or a network-coded packet generated based on the first and second packets, etc. There may be limited opportunities to send a network-coded packet in the sequential scheme, and the delay may be extensive.

For clarity, data transmission from an eNB to a plurality of UEs has been described above. In general, the techniques described herein may be used for data transmission from a transmitter to a plurality of receivers. A transmitter may be a base station, a broadcast station, a relay, a UE, etc. A receiver may be a UE, a broadcast receiver, a relay, etc.

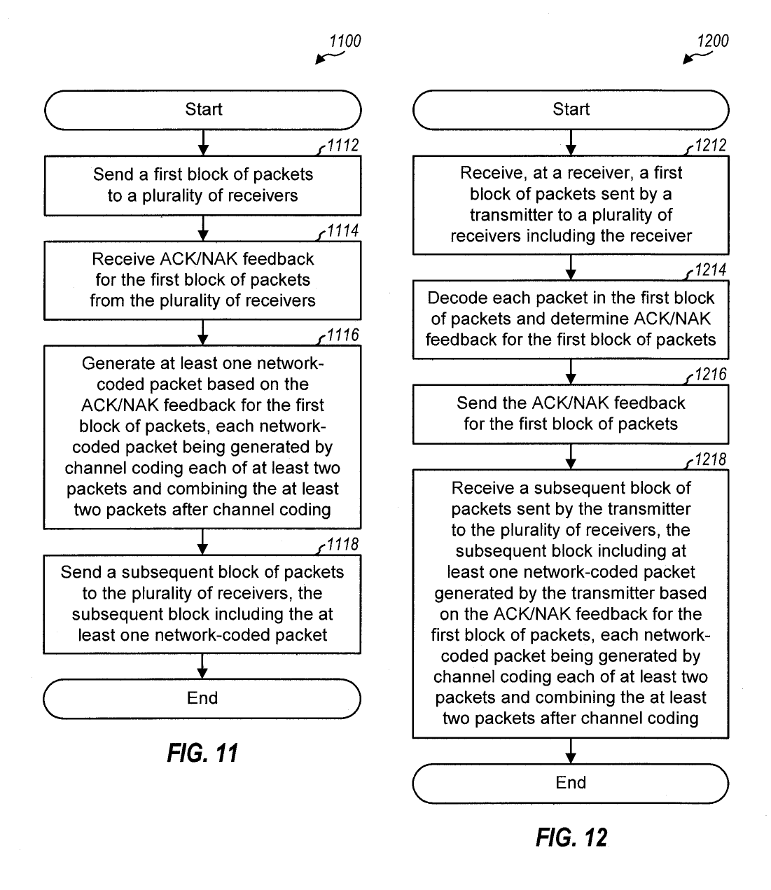

FIG. 11 shows a design of a process 1100 for transmitting data in a wireless communication network. Process 1100 may be performed by a transmitter (e.g., a base station or eNB) or by some other entity. The transmitter may send a first block of packets to a plurality of receivers, which may include UEs and/or other entities (block 1112). The transmitter may receive ACK/NAK feedback for the first block of packets from the plurality of receivers (block 1114). The transmitter may generate at least one network-coded packet based on the ACK/NAK feedback for the first block of packets (block 1116). The transmitter may generate each network-coded packet by channel coding each of at least two packets and then combining the at least two packets after channel coding. The transmitter may send a subsequent block of packets to the plurality of receivers (block 1118). The subsequent block may include the at least one network-coded packet and may further include at least one packet in the first block of packets and/or at least one new packet not included in the first block of packets.

In one design, the transmitter may send a second block of packets to the plurality of receivers and may receive ACK/NAK feedback for the second block of packets from the plurality of receivers, e.g., as shown in FIG. 6B. The transmitter may generate the at least one network-coded packet based further on the ACK/NAK feedback for the second block of packets. Alternatively or additionally, the transmitter may generate the at least one network-coded packet based further on ACK/NAK feedback for a prior transmission of at least one packet in the first block of packets.

In one design, the transmitter may determine a pool of candidate packets for network coding based on the ACK/NAK feedback for the first block of packets. The transmitter may update the pool of candidate packets based on the ACK/NAK feedback for the second block of packets. The transmitter may generate the at least one network-coded packet based on at least one candidate packet in the pool of candidate packets.

The transmitter may identify candidate packets in various manners. In one design, the transmitter may evaluate a plurality of sets of receivers to identify candidate packets to use to generate network-coded packets. The plurality of sets of receivers may correspond to different subsets of the plurality of receivers. The transmitter may identify a candidate packet as a packet that is decoded correctly by all receivers in a set of receivers except for a receiver to which the packet is intended. Alternatively, the transmitter may identity a candidate packet as a packet that is decoded correctly by at least one receiver but not by a receiver to which the packet is intended.

In general, the transmitter may determine the pool of candidate packets for network coding based on partial ACK/NAK feedback for a subset of all packets sent to the plurality of receivers. Alternatively, the transmitter may determine the pool of candidate packets for network coding based on full ACK/NAK feedback for all packets sent to the plurality of receivers. In either case, the transmitter may generate the at least one network-coded packet based on at least one candidate packet in the pool of candidate packets.

In one design of block 1114, the transmitter may encode each of at least two packets previously sent to the plurality of receivers based on a channel code (e.g., a Turbo code, a convolutional code, a block code, etc.) to obtain coded data for each of the at least two packets. The transmitter may combine the coded data for the at least two packets to obtain coded data for a network-coded packet. The transmitter may generate a redundancy version of a network-coded packet based on bit-wise exclusive OR of redundancy versions of the at least two packets.

In one design of block 1112, the transmitter may send a redundancy version of each packet in the first block of packets. In one design of block 1118, the transmitter may send a redundancy version of each packet in the subsequent block of packets. The redundancy version of each packet in the subsequent block of packets may correspond to a redundancy version of a packet in the first block of packets, or a redundancy version of a network-coded packet, or a redundancy version of a new packet not included in the first block of packets.

In one design, the transmitter may send at least one packet in the first block of packets to each receiver on resources assigned to the receiver, e.g., as shown in FIG. 5A. In another design, the transmitter may send the first block of packets on resources shared by the plurality of receivers, e.g., as shown in FIG. 5B.

In one design, the transmitter may send signaling conveying an RNTI assigned to the plurality of receivers. The transmitter may scramble control information for the plurality of receivers based on the RNTI. In another design, the transmitter may send signaling conveying a scrambling sequence used for each packet in the first block of packets. In yet another design, the transmitter may send signaling conveying a list of scrambling sequences available for the first block of packets. Each receiver may descramble each packet based on the scrambling sequence for the packet or the list of scrambling sequences available for the first block of packets.

In one design, the transmitter may send a sequence number of each packet in the first block of packets. The transmitter may identify ACK/NAK feedback for each packet in the first block of packets based on the sequence number for the packet.

FIG. 12 shows a design of a process 1200 for receiving data in a wireless communication network. Process 1200 may be performed by a receiver (as described below) or by some other entity. The receiver may be a UE or some other entity. The receiver may receive a first block of packets sent by a transmitter to a plurality of receivers including the receiver (block 1212). The receiver may decode each packet in the first block of packets and may determine ACK/NAK feedback for the first block of packets (block 1214). The receiver may send the ACK/NAK feedback for the first block of packets (block 1216). The receiver may receive a subsequent block of packets sent by the transmitter to the plurality of receivers (block 1218). The subsequent block may include at least one network-coded packet generated by the transmitter based on the ACK/NAK feedback for the first block of packets. Each network-coded packet may be generated by channel coding each of at least two packets and combining the at least two packets after channel coding.

The receiver may also receive a second block of packets sent by the transmitter to the plurality of receivers. The receiver may send ACK/NAK feedback for the second block of packets. The at least one network-coded packet may be generated by the transmitter based further on the ACK/NAK feedback for the second block of packets. In general, the at least one network-coded packet may be generated based on partial ACK/NAK feedback or full ACK/NAK feedback from the plurality of receivers.

In one design of block 1212, the receiver may receive a redundancy version of each packet in the first block of packets. In one design of block 1218, the receiver may receive a redundancy version of each packet in the subsequent block of packets. The redundancy version of each packet in the subsequent block of packets may correspond to a redundancy version of a packet in the first block of packets, or a redundancy version of a network-coded packet, or a redundancy version of a new packet not included in the first block of packets.

In one design, the receiver may receive signaling conveying an RNTI assigned to the plurality of receivers. The receiver may descramble control information sent to the plurality of receivers based on the RNTI.

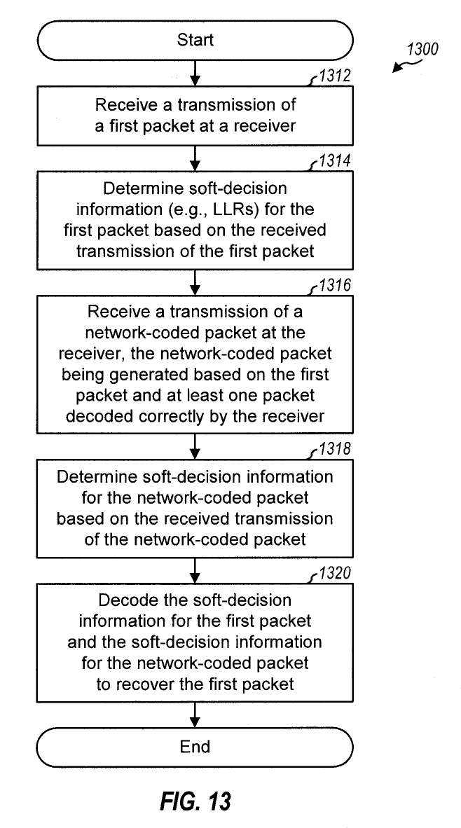

FIG. 13 shows a design of a process 1300 for decoding packets sent with network coding. Process 1300 may be performed by a receiver (as described below) or by some other entity. The receiver may receive a transmission of a first packet (block 1312) and may determine soft-decision information (e.g., LLRs) for the first packet based on the received transmission of the first packet (block 1314). The receiver may also receive a transmission of a network-coded packet, which may be generated by a transmitter based on the first packet and at least one packet decoded correctly by the receiver (block 1316). The receiver may determine soft-decision information for the network-coded packet based on the received transmission of the network-coded packet (block 1318). The receiver may decode the soft-decision information for the first packet and the soft-decision information for the network-coded packet to recover the first packet (block 1320).

In one design, the receiver may determine code bits of the at least one packet decoded correctly by the receiver. The receiver may determine additional soft-decision information for the first packet based on the soft-decision information for the network-coded packet and the code bits of the at least one packet, e.g., based on equations (4) and (6). The receiver may decode the soft-decision information for the first packet and the additional soft-decision information for the first packet to recover the first packet.

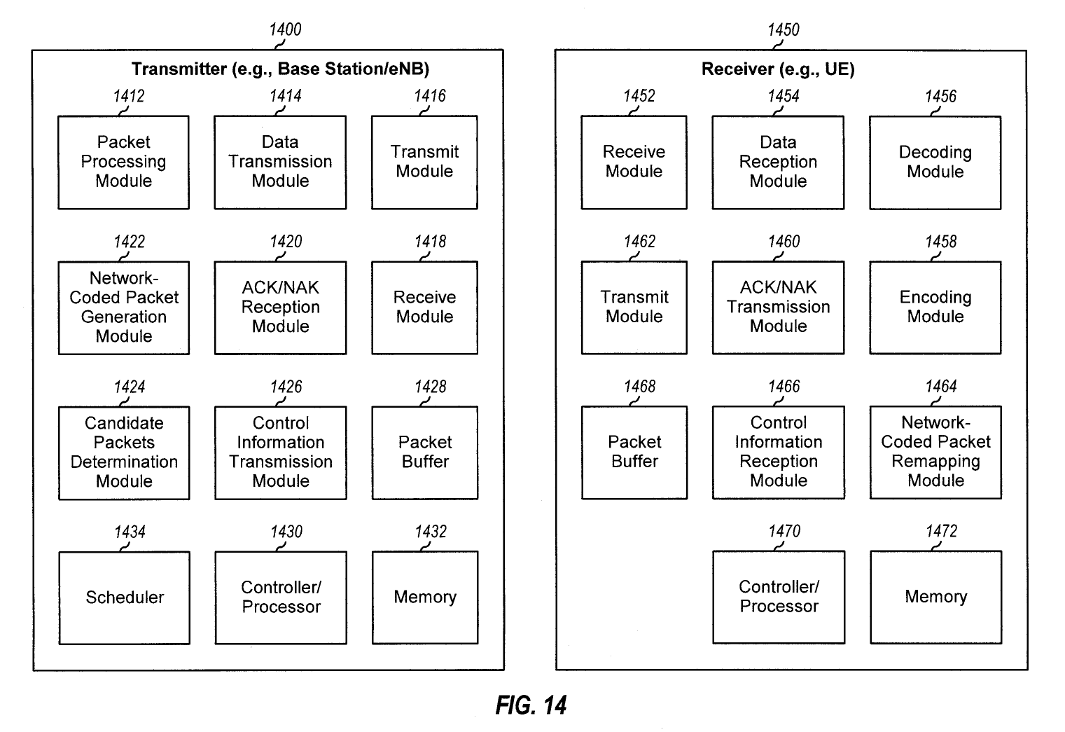

FIG. 14 shows a block diagram of a design of a transmitter 1400 (e.g., a base station/eNB) and a receiver 1450 (e.g., a UE). Within transmitter 1400, a module 1412 may process (e.g., encode) packets for transmission to receivers. A module 1422 may generate network-coded packets based on ACK/NAK feedback from all receivers. A module 1414 may process (e.g., symbol map, modulate, etc.) the packets from module 1412 and the network-coded packets from module 1422 for transmission to receivers. A module 1416 may generate a signal comprising packets, control information, reference signals, etc. A module 1418 may receive and process signals transmitted by the receivers. A module 1420 may receive ACK/NAK feedback sent by the receivers. A module 1424 may determine candidate packets for network coding based on the ACK/NAK feedback from all receivers. Module 1424 may update the candidate packets as more ACK/NAK feedback is received from the receivers. Module 1422 may generate network-coded packets based on the candidate packets. A module 1426 may send control information (e.g., grants for transmissions of packet, special RNTI, scrambling sequences, etc.) to the receivers. A buffer 1428 may store pending packets that have not been decoded successfully by intended receivers as well as new packets to transmit to the receivers. The various modules within transmitter 1400 may operate as described above. A controller/processor 1430 may direct the operation of various modules within transmitter 1400. A memory 1432 may store data and program codes for transmitter 1400. A scheduler 1434 may schedule transmissions of packets and may also assign resources to individual receivers and/or groups of receivers.

Within receiver 1450, a module 1452 may receive and process the signal from transmitter 1400. A module 1454 may process (e.g., demodulate and decode) received transmissions and provide detected symbols. A module 1456 may process the detected symbols and provide decoded packets. For example, module 1456 may compute LLRs of code bits based on the detected symbols and decode the LLRs. Module 1456 may also provide ACK or NAK for each decoded packet. A module 1458 may encode packets that have been decoded successfully by receiver 1450 and used to generate network-coded packets. A module 1464 may determine soft-decision information for packets intended for receiver 1450 based on soft-decision information for network-coded packets and code bits of successfully decoded packets. Module 1456 may decode packets intended for receiver 1450 based on soft-decision information for these packets from modules 1454 and 1464. A module 1460 may generate ACK/NAK feedback for packets decoded by receiver 1450 and may process the ACK/NAK feedback for transmission to transmitter 1400. A module 1462 may transmit a signal comprising the ACK/NAK feedback, other information, and/or data. A module 1466 may receive control information (e.g., grants for transmissions of packet, special RNTI, scrambling sequences, etc.) applicable for receiver 1450. A buffer 1468 may store pending packets intended for receiver 1450 but not decoded successfully by receiver 1450. Buffer 1468 may also store packets not intended for receiver 1450 but successfully decoded by receiver 1450. The various modules within receiver 1450 may operate as described above. A controller/processor 1470 may direct the operation of various modules within receiver 1450. A memory 1472 may store data and program codes for receiver 1450.

The modules in FIG. 14 may comprise processors, electronic devices, hardware devices, electronic components, logical circuits, memories, software codes, firmware codes, etc., or any combination thereof.

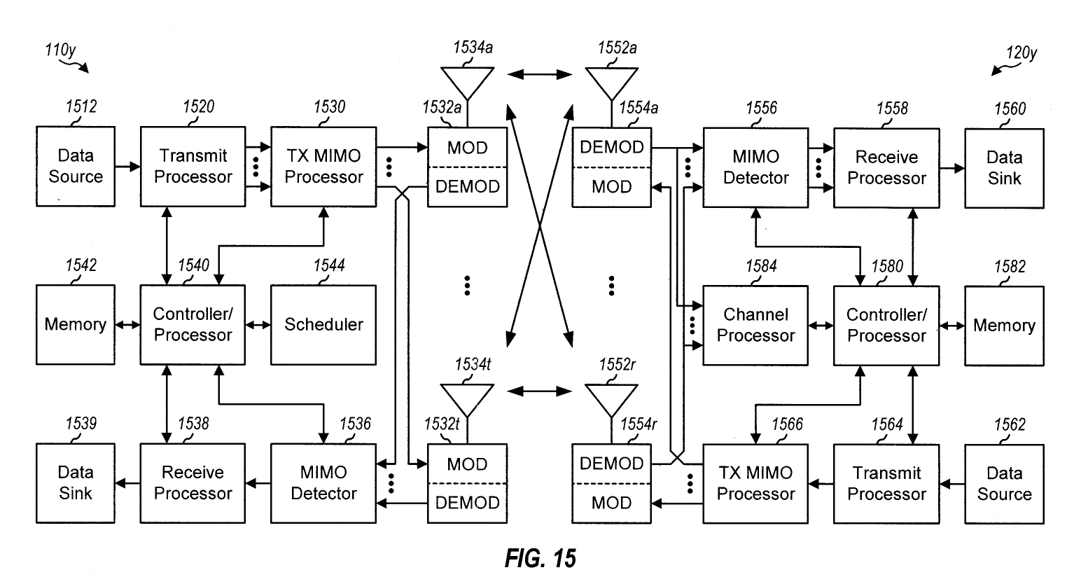

FIG. 15 shows a block diagram of a design of a base station/eNB 110y and a UE 120y, which may be one of the base stations/eNBs and one of the UEs in FIG. 1. Base station 110y may be equipped with T antennas 1534a through 1534t, and UE 120y may be equipped with R antennas 1552a through 1552r, where in general T≧1 and R≧1.

At base station 110y, a transmit processor 1520 may receive packets of data from a data source 1512 for a plurality of UEs, process (e.g., encode and modulate) the packets for each UE based on one or more modulation and coding schemes selected for that UE, and provide data symbols for all UEs. Transmit processor 1520 may also generate network-coded packets based on transmitted packets and may provide data symbols for the network-coded packets. Transmit processor 1520 may implement transmitter 900 in FIG. 9. Transmit processor 1520 may also process control information (e.g., for downlink grants, uplink grants, configuration messages, etc.) and provide control symbols. Processor 1520 may also generate reference symbols for reference signals. A transmit (TX) multiple-input multiple-output (MIMO) processor 1530 may precode the data symbols, the control symbols, and/or the reference symbols (if applicable) and may provide T output symbol streams to T modulators (MOD) 1532a through 1532t. Each modulator 1532 may process its output symbol stream (e.g., for OFDM, etc.) to obtain an output sample stream. Each modulator 1532 may further condition (e.g., convert to analog, amplify, filter, and upconvert) its output sample stream to obtain a downlink signal. T downlink signals from modulators 1532a through 1532t may be transmitted via T antennas 1534a through 1534t, respectively.

At UE 120y, antennas 1552a through 1552r may receive the downlink signals from base station 110y and/or other base stations and may provide received signals to demodulators (DEMODs) 1554a through 1554r, respectively. Each demodulator 1554 may condition (e.g., filter, amplify, downconvert, and digitize) its received signal to obtain input samples. Each demodulator 1554 may further process the input samples (e.g., for OFDM, etc.) to obtain received symbols. A MIMO detector 1556 may obtain received symbols from all R demodulators 1554a through 1554r, perform MIMO detection on the received symbols if applicable, and provide detected symbols. A receive processor 1558 may process (e.g., demodulate and decode) the detected symbols, provide decoded data for UE 120y to a data sink 1560, and provide decoded control information to a controller/processor 1580. Receive processor 1558 may perform decoding based on network-coded packets and may implement receiver 1000 in FIG. 10. A channel processor 1584 may measure the channel quality based on reference signals and may determine CQI.

On the uplink, at UE 120y, a transmit processor 1564 may receive and process packets of data from a data source 1562 and control information (e.g., ACK/NAK feedback, CQI, etc.) from controller/processor 1580. Processor 1564 may also generate reference symbols for one or more reference signals. The symbols from transmit processor 1564 may be precoded by a TX MIMO processor 1566 if applicable, further processed by modulators 1554a through 1554r (e.g., for SC-FDM, OFDM, etc.), and transmitted to base station 110y. At base station 110y, the uplink signals from UE 120y and other UEs may be received by antennas 1534, processed by demodulators 1532, detected by a MIMO detector 1536 if applicable, and further processed by a receive processor 1538 to obtain decoded data and control information sent by UE 120y and other UEs. Processor 1538 may provide the decoded data to a data sink 1539 and the decoded control information to controller/processor 1540.

Controllers/processors 1540 and 1580 may direct the operation at base station 110y and UE 120y, respectively. Processor 1540 and/or other processors and modules at base station 110y may perform or direct the eNB portion of process 400 in FIG. 4, process 1100 in FIG. 11, and/or other processes for the techniques described herein. Processor 1580 and/or other processors and modules at UE 120y may perform or direct the UE portion of process 400 in FIG. 4, process 1200 in FIG. 12, process 1300 in FIG. 13, and/or other processes for the techniques described herein. Memories 1542 and 1582 may store data and program codes for base station 110y and UE 120y, respectively. A scheduler 1544 may schedule UEs for data transmission on the downlink and/or uplink.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
sending a first block of packets to a plurality of receivers;
receiving acknowledgement/negative acknowledgement (ACK/NAK) feedback for the first block of packets from the plurality of receivers;
generating at least one network-coded packet based on the ACK/NAK feedback for the first block of packets, each network-coded packet being generated by channel coding each of at least two packets and combining the at least two packets after channel coding; and
sending a subsequent block of packets to the plurality of receivers, the subsequent block including the at least one network-coded packet.

2. The method of claim 1, further comprising:
sending a second block of packets to the plurality of receivers;
receiving ACK/NAK feedback for the second block of packets from the plurality of receivers; and
generating the at least one network-coded packet based further on the ACK/NAK feedback for the second block of packets.

3. The method of claim 1, further comprising:
determining a pool of candidate packets for network coding based on the ACK/NAK feedback for the first block of packets; and
generating the at least one network-coded packet based on at least one candidate packet in the pool of candidate packets.

4. The method of claim 3, further comprising:
sending a second block of packets to the plurality of receivers;
receiving ACK/NAK feedback for the second block of packets from the plurality of receivers; and
updating the pool of candidate packets based on the ACK/NAK feedback for the second block of packets.

5. The method of claim 1, further comprising:
determining a pool of candidate packets for network coding based on ACK/NAK feedback for a subset of all packets sent to the plurality of receivers; and
generating the at least one network-coded packet based on at least one candidate packet in the pool of candidate packets.

6. The method of claim 1, further comprising:
determining a pool of candidate packets for network coding based on ACK/NAK feedback for all packets sent to the plurality of receivers; and
generating the at least one network-coded packet based on at least one candidate packet in the pool of candidate packets.

7. The method of claim 1, further comprising:
evaluating a plurality of sets of receivers to identify candidate packets to use to generate network-coded packets, the plurality of sets of receivers corresponding to different subsets of the plurality of receivers.

8. The method of claim 1, wherein the generating at least one network-coded packet comprises
encoding each of at least two packets previously sent to the plurality of receivers to obtain coded data for each of the at least two packets, and
combining coded data for the at least two packets to obtain coded data for a network-coded packet.

9. The method of claim 1, wherein the generating at least one network-coded packet comprises
identifying at least two packets previously sent to the plurality of receivers, and
generating a redundancy version of a network-coded packet based on bit-wise exclusive OR of redundancy versions of the at least two packets.

10. The method of claim 1, wherein the sending the first block of packets comprises sending a redundancy version of each packet in the first block of packets.

11. The method of claim 1, wherein the sending the subsequent block of packets comprises:
sending a redundancy version of each packet in the subsequent block of packets, the redundancy version of each packet in the subsequent block of packets corresponding to a redundancy version of a packet in the first block of packets, a redundancy version of a network-coded packet, or a redundancy version of a new packet not included in the first block of packets.

12. The method of claim 1, wherein the sending the first block of packets comprises sending at least one packet in the first block of packets to each receiver among the plurality of receivers on resources assigned to the receiver.

13. The method of claim 1, wherein the sending the first block of packets comprises sending the first block of packets on resources shared by the plurality of receivers.

14. The method of claim 1, further comprising:
sending signaling conveying a Radio Network Temporary Identifier (RNTI) assigned to the plurality of receivers; and
scrambling control information for the plurality of receivers based on the RNTI.

15. The method of claim 1, further comprising:
sending signaling conveying a scrambling sequence used for each packet in the first block of packets.

16. The method of claim 1, further comprising:
sending signaling conveying a list of scrambling sequences available for the first block of packets.

17. The method of claim 1, further comprising:
sending a sequence number of each packet in the first block of packets.

18. The method of claim 17, further comprising:
identifying ACK/NAK feedback for each packet in the first block of packets based on a sequence number of the packet.

19. An apparatus for wireless communication, comprising:
at least one processor configured to:
send a first block of packets to a plurality of receivers;
receive acknowledgement/negative acknowledgement (ACK/NAK) feedback for the first block of packets from the plurality of receivers;
generate at least one network-coded packet based on the ACK/NAK feedback for the first block of packets, each network-coded packet being generated by channel coding each of at least two packets and combining the at least two packets after channel coding; and
send a subsequent block of packets to the plurality of receivers, the subsequent block including the at least one network-coded packet.

20. The apparatus of claim 19, wherein the at least one processor is further configured to:
send a second block of packets to the plurality of receivers;
receive ACK/NAK feedback for the second block of packets from the plurality of receivers; and
generate the at least one network-coded packet based further on the ACK/NAK feedback for the second block of packets.

21. The apparatus of claim 19, wherein the at least one processor is further configured to:
determine a pool of candidate packets for network coding based on ACK/NAK feedback for a subset of all packets sent to the plurality of receivers; and
generate the at least one network-coded packet based on at least one candidate packet in the pool of candidate packets.

22. The apparatus of claim 19, wherein the at least one processor is further configured to:
determine a pool of candidate packets for network coding based on ACK/NAK feedback for all packets sent to the plurality of receivers; and
generate the at least one network-coded packet based on at least one candidate packet in the pool of candidate packets.

23. The apparatus of claim 19, wherein the at least one processor is further configured to:
encode each of at least two packets previously sent to the plurality of receivers to obtain coded data for each of the at least two packets; and
combine coded data for the at least two packets to obtain coded data for a network-coded packet.

24. An apparatus for wireless communication, comprising:
means for sending a first block of packets to a plurality of receivers;
means for receiving acknowledgement/negative acknowledgement (ACK/NAK) feedback for the first block of packets from the plurality of receivers;
means for generating at least one network-coded packet based on the ACK/NAK feedback for the first block of packets, each network-coded packet being generated by channel coding each of at least two packets and combining the at least two packets after channel coding; and
means for sending a subsequent block of packets to the plurality of receivers, the subsequent block including the at least one network-coded packet.

25. The apparatus of claim 24, further comprising:
means for sending a second block of packets to the plurality of receivers;
means for receiving ACK/NAK feedback for the second block of packets from the plurality of receivers; and
means for generating the at least one network-coded packet based further on the ACK/NAK feedback for the second block of packets.

26. The apparatus of claim 24, further comprising:
means for determining a pool of candidate packets for network coding based on ACK/NAK feedback for a subset of all packets sent to the plurality of receivers; and
means for generating the at least one network-coded packet based on at least one candidate packet in the pool of candidate packets.

27. The apparatus of claim 24, further comprising:
means for determining a pool of candidate packets for network coding based on ACK/NAK feedback for all packets sent to the plurality of receivers; and
means for generating the at least one network-coded packet based on at least one candidate packet in the pool of candidate packets.

28. The apparatus of claim 24, wherein the means for generating at least one network-coded packet comprises
means for encoding each of at least two packets previously sent to the plurality of receivers to obtain coded data for each of the at least two packets, and
means for combining coded data for the at least two packets to obtain coded data for a network-coded packet.

29. A computer program product, comprising:
a non-transitory computer-readable medium comprising:
code for causing at least one processor to send a first block of packets to a plurality of receivers;
code for causing the at least one processor to receive acknowledgement/negative acknowledgement (ACK/NAK) feedback for the first block of packets from the plurality of receivers;
code for causing the at least one processor to generate at least one network-coded packet based on the ACK/NAK feedback for the first block of packets, each network-coded packet being generated by channel coding each of at least two packets and combining the at least two packets after channel coding; and
code for causing the at least one processor to send a subsequent block of packets to the plurality of receivers, the subsequent block including the at least one network-coded packet.

30. A method for wireless communication, comprising:
receiving, at a receiver, a first block of packets sent by a transmitter to a plurality of receivers including the receiver;
sending acknowledgement/negative acknowledgement (ACK/NAK) feedback for the first block of packets; and
receiving a subsequent block of packets sent by the transmitter to the plurality of receivers, the subsequent block including at least one network-coded packet generated by the transmitter based on the ACK/NAK feedback for the first block of packets, each network-coded packet being generated by channel coding each of at least two packets and combining the at least two packets after channel coding.

31. The method of claim 30, further comprising:
receiving a second block of packets sent by the transmitter to the plurality of receivers; and
sending ACK/NAK feedback for the second block of packets, wherein the at least one network-coded packet is generated by the transmitter based further on the ACK/NAK feedback for the second block of packets.

32. The method of claim 30, wherein the receiving the first block of packets comprises receiving a redundancy version of each packet in the first block of packets.

33. The method of claim 30, wherein the receiving the subsequent block of packets comprises receiving a redundancy version of each packet in the subsequent block of packets, the redundancy version of each packet in the subsequent block of packets corresponding to a redundancy version of a packet in the first block of packets, or a redundancy version of a network-coded packet, or a redundancy version of a new packet not included in the first block of packets.

34. The method of claim 30, further comprising:
receiving signaling conveying a Radio Network Temporary Identifier (RNTI) assigned to the plurality of receivers; and
descrambling control information sent to the plurality of receivers based on the RNTI.

35. An apparatus for wireless communication, comprising:
at least one processor configured to:
receive, at a receiver, a first block of packets sent by a transmitter to a plurality of receivers including the receiver;
send acknowledgement/negative acknowledgement (ACK/NAK) feedback for the first block of packets; and
receive a subsequent block of packets sent by the transmitter to the plurality of receivers, the subsequent block including at least one network-coded packet generated by the transmitter based on the ACK/NAK feedback for the first block of packets, each network-coded packet being generated by channel coding each of at least two packets and combining the at least two packets after channel coding.

36. The apparatus of claim 35, wherein the at least one processor is further configured to:
receive a second block of packets sent by the transmitter to the plurality of receivers; and
send ACK/NAK feedback for the second block of packets, wherein the at least one network-coded packet is generated by the transmitter based further on the ACK/NAK feedback for the second block of packets.

37. The apparatus of claim 35, wherein the at least one processor is further configured to receive a redundancy version of each packet in the first block of packets.

38. The apparatus of claim 35, wherein the at least one processor is further configured to receive a redundancy version of each packet in the subsequent block of packets, the redundancy version of each packet in the subsequent block of packets corresponding to a redundancy version of a packet in the first block of packets, or a redundancy version of a network-coded packet, or a redundancy version of a new packet not included in the first block of packets.

39. An apparatus for wireless communication, comprising:
means for receiving, at a receiver, a first block of packets sent by a transmitter to a plurality of receivers including the receiver;
means for sending acknowledgement/negative acknowledgement (ACK/NAK) feedback for the first block of packets; and
means for receiving a subsequent block of packets sent by the transmitter to the plurality of receivers, the subsequent block including at least one network-coded packet generated by the transmitter based on the ACK/NAK feedback for the first block of packets, each network-coded packet being generated by channel coding each of at least two packets and combining the at least two packets after channel coding.

40. The apparatus of claim 39, further comprising:
means for receiving a second block of packets sent by the transmitter to the plurality of receivers; and
means for sending ACK/NAK feedback for the second block of packets, wherein the at least one network-coded packet is generated by the transmitter based further on the ACK/NAK feedback for the second block of packets.

41. The apparatus of claim 39, wherein the means for receiving the first block of packets comprises means for receiving a redundancy version of each packet in the first block of packets.

42. The apparatus of claim 39, wherein the means for receiving the subsequent block of packets comprises means for receiving a redundancy version of each packet in the subsequent block of packets, the redundancy version of each packet in the subsequent block of packets corresponding to a redundancy version of a packet in the first block of packets, or a redundancy version of a network-coded packet, or a redundancy version of a new packet not included in the first block of packets.

43. A computer program product, comprising:
a non-transitory computer-readable medium comprising:
code for causing at least one processor to receive, at a receiver, a first block of packets sent by a transmitter to a plurality of receivers including the receiver;
code for causing the at least one processor to send acknowledgement/negative acknowledgement (ACK/NAK) feedback for the first block of packets; and
code for causing the at least one processor to receive a subsequent block of packets sent by the transmitter to the plurality of receivers, the subsequent block including at least one network-coded packet generated by the transmitter based on the ACK/NAK feedback for the first block of packets, each network-coded packet being generated by channel coding each of at least two packets and combining the at least two packets after channel coding.

44. A method for wireless communication, comprising:
receiving a transmission of a first packet at a receiver;
determining soft-decision information for the first packet based on the received transmission of the first packet;
receiving a transmission of a network-coded packet at the receiver, the network-coded packet being generated by a transmitter based on the first packet and at least one packet decoded correctly by the receiver;
determining soft-decision information for the network-coded packet based on the received transmission of the network-coded packet; and
decoding the soft-decision information for the first packet and the soft-decision information for the network-coded packet to recover the first packet.

45. The method of claim 44, further comprising:
determining code bits of the at least one packet decoded correctly by the receiver; and
determining additional soft-decision information for the first packet based on the soft-decision information for the network-coded packet and the code bits of the at least one packet, wherein the decoding comprises decoding the soft-decision information for the first packet and the additional soft-decision information for the first packet to recover the first packet.

46. An apparatus for wireless communication, comprising:
at least one processor configured to:
receive a transmission of a first packet at a receiver;
determine soft-decision information for the first packet based on the received transmission of the first packet;
receive a transmission of a network-coded packet at the receiver, the network-coded packet being generated by a transmitter based on the first packet and at least one packet decoded correctly by the receiver;
determine soft-decision information for the network-coded packet based on the received transmission of the network-coded packet; and
decode the soft-decision information for the first packet and the soft-decision information for the network-coded packet to recover the first packet.

47. The apparatus of claim 46, wherein the at least one processor is further configured to:
determine code bits of the at least one packet decoded correctly by the receiver;
determine additional soft-decision information for the first packet based on the soft-decision information for the network-coded packet and the code bits of the at least one packet; and
decode the soft-decision information for the first packet and the additional soft-decision information for the first packet to recover the first packet.

48. An apparatus for wireless communication, comprising:
means for receiving a transmission of a first packet at a receiver;
means for determining soft-decision information for the first packet based on the received transmission of the first packet;
means for receiving a transmission of a network-coded packet at the receiver, the network-coded packet being generated by a transmitter based on the first packet and at least one packet decoded correctly by the receiver;
means for determining soft-decision information for the network-coded packet based on the received transmission of the network-coded packet; and
means for decoding the soft-decision information for the first packet and the soft-decision information for the network-coded packet to recover the first packet.

49. The apparatus of claim 48, further comprising:
means for determining code bits of the at least one packet decoded correctly by the receiver; and
means for determining additional soft-decision information for the first packet based on the soft-decision information for the network-coded packet and the code bits of the at least one packet,
wherein the means for decoding comprises means for decoding the soft-decision information for the first packet and the additional soft-decision information for the first packet to recover the first packet.

50. A computer program product, comprising:
a non-transitory computer-readable medium comprising:
code for causing at least one processor to receive a transmission of a first packet at a receiver;
code for causing the at least one processor to determine soft-decision information for the first packet based on the received transmission of the first packet;
code for causing the at least one processor to receive a transmission of a network-coded packet at the receiver, the network-coded packet being generated by a transmitter based on the first packet and at least one packet decoded correctly by the receiver;
code for causing the at least one processor to determine soft-decision information for the network-coded packet based on the received transmission of the network-coded packet; and
code for causing the at least one processor to decode the soft-decision information for the first packet and the soft-decision information for the network-coded packet to recover the first packet.
